(19) United States
(12) Patent Application Publication
(10) Pub. No.: US 2024/0100762 A1
(43) Pub. Date: Mar. 28, 2024

(54) MELT CONVEYOR FOR AN EXTRUSION TOOL OF AN EXTRUSION SYSTEM, EXTRUSION TOOL, EXTRUSION SYSTEM AND METHOD FOR OPERATING AN EXTRUSION SYSTEM OF THIS TYPE

(71) Applicant: REIFENHÄUSER GMBH & CO. KG MASCHINENFABRIK, Troisdorf (DE)

(72) Inventors: Helmut MEYER, Troisdorf (DE); Volkmar KRUK, Meerbusch (DE); Tim POHL, Köln (DE); Hans-Georg GEUS, Niederkassel (DE); Anna Klara ROTTSTEGGE, Köln (DE)

(21) Appl. No.: 17/768,316

(22) PCT Filed: Oct. 14, 2020
(86) PCT No.: PCT/DE2020/200087

§ 371 Date: Apr. 12, 2022

(30) Foreign Application Priority Data
Oct. 15, 2019 (DE) 10 2019 007 153.0
Jul. 10, 2020 (DE) 10 2020 118 214.7

(51) Int. Cl. B29C 48/70; B01F 25/432; B29B 7/32; B29B 7/72; B29C 48/255; B29C 48/36; B29C 48/92

(52) U.S. Cl. CPC B29C 48/705; B01F 25/4323; B29B 7/325; B29B 7/72; B29C 48/2556; B29C 48/362; B29C 48/92; B01F 2101/2805; B29C 2948/92209; B29C 2948/92409; B29C 2948/926; B29C 2948/92704; B29C 2948/92904

(57) ABSTRACT

Melt conductor (1), in particular melt distributor or melt mixer, for an extruding die (2) of an extrusion facility (3), having a melt conductor block (4) with a multi-channel system (5), the multi-channel system (5) being arranged so as to extend three-dimensionally inside the melt conductor block (4) and having at least one input (6) and at least one output (7) for polymer melt, between one input (6) and one output (7) fluidically connected to the input (6) several branchings (8) arranged in series and several levels (9a, 9b, 9c) of sub-branches (10) being formed over several levels (12a, 12b) of divided melt channels (11a, 11b), m melt channels (11a) of the a^{th} level (12a) with x^{th} local cross-sections and n melt channels (11b) of the b^{th} level (12b) with y^{th} local cross-sections being present, wherein n>m if b>a, the y^{th} local cross-sections of the melt channels (11b) of the b^{th} level (12b) being smaller than the x^{th} local cross-sections of the melt channels (11a) of the a^{th} level (12a),

and wherein in the area of the multi-channel system (5), means for at least indirectly influencing polymer melt are arranged.

The invention relates to a melt conductor for an extruding die of an extrusion facility, having a melt conductor block with a multi-channel system.

The invention further relates to an extruding die for at least indirectly extruding or manufacturing extrusion products such as films, nonwoven fabrics, profiles, pipes, blow-molded parts, filaments, plates, semi-finished products, hoses, cables, compounds or semi-finished foam products. An extruding die generally comprises one or more melt conductors embodied as melt distributors and/or melt mixers. The extruding die is designed to distribute and/or to mix a polymer melt which is provided and fed in by at least one provision unit, and to conduct the polymer melt directly into the environment of the extruding die, depending on the embodiment of the melt conductor or melt conductors. In such case, one or more outputs of the respective melt conductor function(s) as extrusion nozzle(s) or as nozzle output(s). Alternatively, a separate extrusion nozzle can be arranged downstream of the melt conductor or melt conductors, which is fed with polymer melt by one or more melt conductor(s) and conducts the polymer melt from the extruding die to the environment, at least indirectly. In this case, that is, the extruding die comprises melt conductor(s) as well as an extrusion nozzle downstream of the designated polymer melt.

The melt conductor(s) and the extrusion nozzle can be separate components. It is also conceivable, however, for the melt conductor(s) and the extrusion nozzle to be made in one piece. That is, the extruding die can be an assembly consisting of the abovementioned components as well as other components, depending on design and requirements of the extrusion facility. The nozzle outputs of the melt conductor, or the extrusion nozzle, respectively, are therefore the components forming the extrusion product in the direction of flow of the polymer melt.

A melt mixer is a component or an assembly which receives a plasticized polymer melt in one or more inputs, with the polymer melt being subsequently combined and mixed via intersecting or combined melt channels, until the polymer melt exits from the melt mixer at one or more outputs the number of which is lower than that of the inputs. That is, the polymer melt is at first divided into a plurality of melt filaments conducted in a plurality of melt channels and combined by and by through the multi-channel system. In other words, the melt mixer has melt channels in a direction opposite to the designated direction of flow of the polymer melts, which channels are divided into at least one main branch and several levels of sub-branches. Reversely, melt channels and therefore also the melt filaments are combined in the designated direction of flow of the polymer melts by means of several levels of combination ducts, so that at an output side of the melt mixer there are fewer outputs than inputs at an input side of the melt mixer.

A melt distributor, in contrast, is a component or an assembly which receives a plasticized polymer melt in one or more inputs, the polymer melt being subsequently divided into different melt channels until the polymer melt is output at one or more outputs the number of which is larger than that of the inputs in the melt distributor. Therefore, the polymer melt is by and by divided by the multi-channel system into a plurality of melt filaments conducted in melt channels. In other words, the melt distributor has melt channels in a designated direction of flow of the polymer melt, which melt channels are divided into melt sub-channels via at least one main branch and several levels of sub-branches. Reversely, melt channels are combined via several levels of combination ducts in a direction opposite to the designated direction of flow of the polymer melt such that at an output side of the melt mixer, there are more outputs than there are inputs at an input side of the melt mixer.

The invention also relates to an extrusion facility which is embodied particularly as a cast film, meltblown, spunbond, blown-film, monofilament or multifilament line and comprises an extruding die with at least one melt conductor of the abovementioned type. The extrusion facility is substantially designed to receive an extrudible polymer, convert it into or process it as a polymer melt and then create an extrusion product by suitably conducting the polymer melt and subsequently atomizing the same.

The term “extrudible polymer” substantially designates materials, mixtures and commercial additives thereof which are extrudible, i.e. can be processed by an extruder. In particular, it designates thermoplasts, such as polyvinylchloride (PVC), polyethylene (PE), polypropylene (PP), polyamide (PA), acrylonitrile butadiene styrene copolymer (ABS) polycarbonate (PC) styrene-butadiene (SB), polymethylmethacrylate (PMMA) polyurethane (PUR) polyethyleneterephthalate (PET), polyvinylalcohol (PVOH, PVAL) or polysulfone (PSU). In particular, the polymer can be a plastic polymer. Additionally, biomaterials such as thermoplastic starch, solutions and other materials are extrudible and can be used for the present solution instead of or in combination with a plastic polymer. For simplicity, the terms “polymer” or “plastic polymer” will generally be used in the context of the present patent application.

The extrudible polymer can be provided to the extrusion facility in substantially solid form, for example as a granulate, a powder or in the form of flakes. Alternatively, it is conceivable that at least part of the extrudible polymer is available in substantially liquid form. The provision unit providing the extrudible polymer can be, for instance, a reservoir providing the polymer in the form suitable for the melt conductor so as to feed the melt conductor. Alternatively, the provision unit can be an extruder which converts the extrudible polymer in advance into a phase optimal for feeding the melt conductor, for instance from a substantially solid form into a substantially liquid form. In feeding the melt conductor, the polymer melt is normally substantially completely molten or plasticized or in solution and is subsequently divided and/or combined through the melt conductor. It is also possible that part of the polymer is present in substantially solid form or is supplemented to the substantially liquid polymer melt as an additive before feeding of the melt conductor, the solid component having a different melting temperature than molten or liquid component. In other words, the polymer in this case consists of at least two components provided to the melt conductor together or separately.

The invention further relates to a method of operating an extrusion facility.

Generic melt conductors and extrusion dies are known from the state of the art of extrusion technology and can be implemented in various embodiments.

Extrusion dies with a circular or ring gap-shaped cross-section of the extrusion nozzle are known. For instance, there are spiral mandrels for feeding circular dies with a polymer melt from a provision unit, the spiral mandrels having helical grooves provided on the outside or the inside of a lateral surface of a mandrel or a sleeve. In this connection, there are also sleeve distributors or mandrel holders by means of which the polymer melt can be distributed evenly such that a film tubing or a profile can exit from the extruding die.

Furthermore, extruding dies with a slot-shaped output cross-section of the extrusion nozzle are also known. It is the purpose of the melt conductor of such an extruding die to feed a polymer melt provided by a provision unit as evenly as possible to the nozzle outputs or the extrusion nozzle, respectively, so that a necessary amount of polymer melt is available over the desired width at each position of the nozzle output. State of the art are in particular melt conductor systems in the form of T distributors, fishtail distributors or coathanger distributors.

Extruding dies with a plurality of individual output cross-sections are known as well. It is the aim of the melt conductor of this extruding die to feed a polymer melt provided by a provision unit as evenly as possible to the nozzle outputs or the extrusion nozzle, respectively. Depending on the field of application, these melt conductors are formed as T distributors, coathanger distributors, line distributors, channel distributors, step distributors, sleeve distributors, spiral mandrels or gap distributors.

Most known melt conductors have a multi-part construction, with at least two melt conductor halves being screwed together. In addition, there are also weld structures. It is increasingly problematic that with ever increasing dimensions of the extruding dies, the dimensions of a melt conductor increase as well, causing the pressure inside the die due to shear stresses of the polymer melt and consequently the stresses on the components, particularly on the components conducting the polymer melt, to rise. This leads to limitations in construction and dimensioning in particular of the extruding die, especially if products with a small extrusion cross-section are extruded.

In any case, such melt conductors are employed to evenly distribute or combine a polymer melt provided substantially continuously from a provision unit from an input side of the melt conductor with an input overall cross-section to an output side of the melt conductor with an output overall cross-section substantially altered in terms of geometry and space with respect to the input overall cross-section.

It is therefore the task of a melt conductor in the form of a melt distributor to provide the polymer melt downstream on the output side of the melt distributor with a larger output overall cross-section than it was fed to the melt conductor upstream. In other words, the polymer melt must be evenly distributed from a first overall throughput cross-section to a second overall throughput cross-section with a larger width, where the respective output melt channel cross-section is not necessarily rectilinear, as is the case with a slit die on the output side, but can also be arc-shaped or circular, as in a circular die arranged at the output side. In any case, the overall circumference of the second overall throughput cross-section, that is, the sum of all circumferences of the melt channels at the output side of the melt conductor, is much larger than that of the first overall throughput cross-section at the input side of the melt conductor.

In contrast, the task of a melt conductor in the form of a melt mixer is to provide the polymer melt downstream on the output side of the melt distributor with a smaller output overall cross-section than it was fed to the melt conductor upstream. In other words, the polymer melt must be evenly guided and mixed from a first overall throughput cross-section to a second overall throughput cross-section with a substantially smaller overall cross-sectional area, where in this case as well, the respective output melt channel cross-section is not necessarily rectilinear.

As a rule, the polymer melt is continuously provided at the input side of the melt conductor by at least one provision unit, in particular by at least one extruder or the like, and is fed to the melt conductor. At the output side of the melt conductor, the polymer melt is at least indirectly atomized so as to continuously produce an extrusion product.

For instance, DE 21 14 465 A discloses a device for the even distribution of thermoplastics from at least one extruder head nozzle to several blow heads or pointed heads, the device having a massive distributor block in which a plurality of bore holes and additional bolts are introduced so as to implement melt ducts and deflection means within the massive distributor block.

In EP 0 197 181 B1, a method of manufacturing a composite injection molding distributor is described, the injection molding distributor having different branchings for transferring melt from a common inlet opening to a plurality of outlet openings. The injection molding distributor is composed of two plates with opposite surfaces, made of tool steel and screwed together, the surfaces having matching grooves for forming melt channels inside the melt distributor.

From DE 197 03 492 A1, a melt distributor for a plastic melt plasticized in an extruder is known, which melt is divided into several individual strands for different processing tools after having been pressed out of an extrusion nozzle. The melt distributor has a feed channel and a connected carbine with distributor channels, the number of distributor channels corresponding to the number of processing tools, and the center points of the openings of the distributor channels formed on the carbine being positioned on one circle so as to be able to provide a plastic melt with temperature profiles as equal as possible at all processing tools.

Whenever in the present patent application a “melt conductor” is mentioned, this indicates a melt conductor of an extrusion facility which either has nozzle outputs for originating extrusion products itself or is adapted for feeding a shaping extrusion nozzle. That is, a melt conductor is indicated which is part of an extruding die of an extrusion facility. The wording “for an extruding die of an extrusion facility” in the Claims is not intended to indicate that the extruding die or the facility are necessarily part of the respective Claim, but instead only suitability is disclosed. Furthermore, the wording “for an extrusion facility” is not intended to imply that the facility is compulsorily part of the respective Claim.

The invention is based on the task of further developing melt conductors and of overcoming the drawbacks thereof. In particular, the invention is based on the task of further developing extruding dies, extrusion facilities and corresponding methods, in particular for operating such extrusion facilities.

According to the invention, this task is solved by a melt conductor having the features of the independent claim 1. Advantageous further developments of the melt conductor result from the dependent claims 2 through 12. Furthermore, the object of the invention is achieved by an extruding die according to claim 13. Advantageous further developments of the extruding die result from the dependent claim 14. The task of the invention is further achieved by an extrusion facility according to claim 15. In addition, the task of the invention is achieved by a method of operating a facility according to claim 16.

In a first aspect of the present invention, this task is solved by a melt conductor, in particular a melt distributor or melt mixer, for an extruding die of an extrusion facility, having a melt conductor block with a multi-channel system,
the multi-channel system being arranged three-dimensionally within the melt conductor block and having at least one input and at least one output for polymer melt,
where between an input and an output fluidically connected to the input, several branchings arranged behind one another and several levels of further branchings are formed over several levels of separated melt channels,
m melt channels of level a with x^{th} local cross-sections and n melt channels of level b with y^{th} local cross-sections being present,
wherein n>m if b>a,
where the y^{th} local cross-sections of the melt channels of the b^{th} level are smaller than the x^{th} local cross-sections of the melt channels of the a^{th} level
and where
in the designated direction of flow of the polymer melt, the melt channels of the a^{th} level are oriented toward the input and the melt channels of the b^{th} level toward the output such that the melt conductor serves a melt distributor for a designated melt stream of the polymer melt, or
in the designated direction of flow of the polymer melt, the melt channels of the a^{th} level are oriented toward the output and the melt channels of the b^{th} level toward the input such that the melt conductor serves a melt mixer for a designated melt stream of the polmyer melt,
and where in the area of the multi-channel system, means for at least indirectly influencing the polymer melt are arranged.

First, it is explicitly pointed out that within the framework of the present patent application, indefinite articles and numerals such as “one”, “two” etc. are normally to be understood as indicating a minimum, i.e. “at least one . . . ”, “at least two . . . ” etc. unless it becomes explicitly clear from the respective context or is obvious or technically indispensable for the person skilled in the art that only “exactly one . . . ”, “exactly two . . . ” etc. can be intended.

Additionally, all numerals and all information on method and/or device parameters are to be understood in the technical sense, i.e. taking into account the usual tolerances.

Even if the restrictive wordings “at least” or the like are used, this does not mean that if it simply says “one”, i.e. without the use of “at least” or the like, “exactly one” is intended.

Some terminology will be explained in the following:

A “melt conductor” is a component or an assembly comprising a melt conductor block with a multi-channel system which is adapted, depending on the embodiment of the multi-channel system, to distribute and/or combine a polymer melt fed to the melt conductor. The melt conductor can be embodied exclusively as a melt distributor distributing the designated polymer melt from at least one input on a plurality of outputs. Furthermore, the melt conductor can be embodied exclusively as a melt mixer which combines the designated polymer melt from two or more inputs to an overall number of outputs which is lower than the number of inputs. Alternatively, the melt conductor can be embodied partly as a melt distributor and partly as a melt mixer, in any order, such that the designated polymer melt can be distributed and combined as desired, with the number of in- and outputs being selectable as desired. The melt conductor is preferably at least partly manufactured by means of an additive manufacturing method.

The “melt conductor block” is the component of the melt conductor which entirely or partly accommodates the multi-channel system. The melt conductor block is preferably formed by means of an additive manufacturing method. It can be a base body formed massive or with support structures, for instance in skeletal construction. The support structures can be formed to guarantee static stability of the melt conductor block and further to support the multi-channel system. If the melt conductor is embodied as a melt distributor, the term “melt conductor block” will be used as a synonym for the melt conductor block in the following. In an analogous manner, the term “melt mixer block” will be used as a synonym for the melt conductor block if the melt conductor is embodied as a melt mixer. A plurality of melt conductor blocks can be provided which are arranged to be stationary with respect to one another and form the melt conductor in a modular manner, the individual melt conductor blocks thus being preferably replaceable and arranged with respect to one another such that easy assembly and/or maintenance of the melt conductor is possible. In other words, the melt conductor blocks can be interconnected releasably, e.g. by means of mutual bracing, but also non-releasably, that is in particular by material engagement. By a releasable connection, for instance, bracing, an embodiment of the individual melt conductor blocks such that they can be disassembled or replaced in a nondestructive manner, for instance in case of damage, for maintenance purposes, for transport or the like, is intended.

A “melt channel” is a substantially longitudinal portion of the multi-channel system conducting a polymer melt (or a melt stream of the polymer melt) which can extend exclusively longitudinally or straight or which can have curvatures so as to achieve a three-dimensional embodiment of the multi-channel system. A plurality of such melt channels are fluidically interconnected via branchings and sub-branches which thus form the multi-channel system, where two or more melt channels can be arranged in series and/or in parallel so as to distribute and/or mix the polymer melt according to the requirements made on the melt conductor. The melt channels extend from the respective input to the respective output which is fluidically connected to the input.

The respective melt channel can be embodied as desired. It is possible, for instance, for it to have a substantially unaltered melt channel cross-section, that is a local cross-section of any shape which extends between the branchings over the entire length of the melt channel The local cross-section can have a substantially circular cross-section, a substantially oval or elliptical cross-section and/or a substantially rectangular or square cross-section. Alternatively, a cross-sectional shape deviating from the well-known standard geometric shapes can be selected for the melt channel, in particular in transition points between the known standard shapes. Whenever within the framework of this invention a specific cross-sectional shape of a melt channel is mentioned, it is intended that the respective melt channel has this substantially constant cross-sectional shape or local cross-section over a major part of its axial extension, preferably over more than or equal to 50% of the length of the respective melt channel, preferably over at least ⅔ of the length of the channel, preferably over at least ¾ of the length of the channel.

Melt channels arranged serially behind one another and fluidically interconnected via branchings or sub-branches are described within the framework of the present patent application as divided into “levels” designated in ascending or descending alphabetic order depending on the embodiment of the melt conductor and in dependence on the direction of flow of the designated polymer melt. The same applies to branchings and sub-branches which are also designated by levels in ascending or descending order.

The “designated direction of flow” of the polymer melt refers to the arrangement of the melt conductor in the extrusion facility and to the embodiment of the multi-channel system, where the direction of flow is always from an input to an output fluidically connected to the input, independently of whether the polymer melt is distributed and/or mixed in the multi-channel system. In particular, the designated direction of flow of the polymer melt is from an input side to an output side of the melt conductor.

A “multi-channel system” is a channel structure within the melt conductor which is preferably at least partly produced by means of an additive manufacturing method, which is integrated in the melt conductor block and which extends three-dimensionally inside it. The multi-channel system consists of a plurality of fluidically interconnected melt channels which extend from at least one input to at least one output fluidically connected to the input, and which are fluidically interconnected via branchings and sub-branches or via combination ducts, depending on the embodiment of the melt conductor. The melt channels of the multi-channel system are fluidically interconnected behind one another in series or arranged in parallel. With serial arrangement, at least one melt channel of the a^{th} level is fluidically connected to at least one melt channel of the b^{th} level via a branching or sub-branch, the melt channel of the a^{th} level being located upstream or downstream, in the designated direction of flow of the polymer melt, of the respective melt channel of the b^{th} level, depending on the embodiment of the melt conductor as a distributor or a mixer. In other words, the melt channel of the a^{th} level is fluidically connected to the melt channel of the b^{th} level via a branching or a combination duct. In contrast, several, preferably all, melt channels of one level are arranged in parallel.

An “input” of the multi-channel system is the input of the multi-channel system into the melt conductor block the polymer melt provided by a provision unit is fed into. In other words, the input is arranged at an input side of the melt conductor block.

In contrast, an “output” of the multi-channel system is the output of the multi-channel system from the melt conductor block from which the polymer melt guided, distributed and/or combined through the melt conductor block exits. The output can be formed as a nozzle and therefore be a nozzle output. Alternatively or in addition, the output can be formed such as to feed an extrusion nozzle connected downstream of the melt conductor which accordingly atomizes the polymer melt so as to at least indirectly produce an extrusion product. Therefore, the output is arranged at an output side of the melt conductor block.

The melt conductor block thus has an input side and an output side, the input side with the respective input being arranged downstream of the provision unit with respect to the designated direction of flow of a polymer melt and the output side with the respective output being arranged upstream of an extrusion nozzle or downstream of the input side with the respective input.

When the present melt conductor is embodied as a melt distributor, the melt conductor has more outputs than inputs since the respective input is preferably fluidically connected to a plurality of outputs via at least two levels of separated melt channels. To prevent a melt flow interruption of the designated polymer melt, protect the multi-channel system from undesired deposits and keep the shearing stresses in the multi-channel system substantially constant, an overall cross-section of all local cross-sections of the melt channels of one level increases with each ascending level. On the one hand, the respective local cross-section of the n melt channels of the b^{th} level decreases in comparison to the respective local cross-section of the m melt channels of the a^{th} level; on the other hand, the number of melt channels increases with each level, that is, with ascending order of the alphabet. In other words, the melt channel of the a^{th} level is oriented towards the input whereas the melt channel of the b^{th} level is oriented towards the output and follows after the melt channel of the a^{th} level in the designated direction of flow of the polymer melt. Correspondingly, a melt channel of the c^{th} level follows after the melt channel of the b^{th} level in the designated direction of flow of the polymer melt etcetera, where the melt channel of the c^{th} level is also oriented towards the output with respect to the melt channels of the a^{th} and the b^{th} level. The melt channel of the b^{th} level is oriented towards the input with respect to the melt channel of the c^{th} level. A melt channel of an a^{th} level is divided into at least two melt channels of a b^{th} level, with a melt channel of the b^{th} level being subdivided into at least two melt channels of a c^{th} level etcetera. Thus, the alphabetic order of the levels of melt channels ascends and the number of melt channels increases from level to level along the designated direction of flow of the polymer melt.

If the present melt conductor is a melt mixer, the melt conductor has more inputs than outputs since at least two of the inputs are fluidically connected to a lower number of outputs via preferably at least two levels of joined melt channels. The overall cross-section of all local cross-sections of the melt channels of one level is reduced with descending levels so as to prevent melt flow interruption of the designated polymer melt and keep the wall shear stresses in the multi-channel system substantially constant. On the one hand, the respective local cross-section of the n melt channels of the b^{th} level increases in comparison to the respective local cross-section of the m melt channels of the a^{th} level; on the other hand, the number of melt channels decreases with each level, that is, with descending order of the alphabet. In other words, using an example of three levels of melt channels in the multi-channel system, the melt channel of the c^{th} level is oriented towards the input whereas the melt channel of the b^{th} level is oriented towards the output and follows after the melt channel of the c^{th} level in the designated direction of flow of the polymer melt. Correspondingly, a melt channel of the a^{th} level follows after the melt channel of the b^{th} level in the designated direction of flow of the polymer melt and is also oriented toward the output with respect to the melt channels of the c^{th} and b^{th} levels. In contrast, the melt channel of the b^{th} level is oriented towards the output with respect to the melt channel of the c^{th} level. This means that at least two melt channels of a c^{th} level are joined to a lower number of melt channels of a b^{th} level, with in turn at least two melt channels of the b^{th} level being joined to a lower number of melt channels of an a^{th} level. Thus, the alphabetic order of the levels of melt channels ascends and the number of melt channels increases from level to level opposite to the designated direction of flow of the polymer melt.

Moreover, it is conceivable to embody the melt conductor partly as a melt distributor and partly as a melt mixer. For example, it is possible that first one melt channel of an a^{th} level is divided into at least two melt channels of a b^{th} level, whereupon one melt channel of a b^{th} level is divided into at least two melt channels of a c^{th} level so that at first the polymer melt is distributed from level to level. At least two melt channels of the c^{th} level can then be recombined to a lower number of melt channels of a b′^{th} level, whereupon at least two melt channels of the b′^{th} level can be recombined to melt channels of the a′^{th} level etcetera so that a combination of the polymer melt takes place from level to level. A reverse order in which first melt channels are joined and then separated as well as any desired combination of distributions and combinations is conceivable depending on the requirements on the polymer melt and the extrusion product produced therefrom.

The wording “oriented towards” within the framework of the invention is to be understood as an arrangement of a melt channel and/or a branching or sub-branch of a first level in relation to a further level. If a multi-channel system has, for instance, a^{th}, b^{th} and c^{th} levels of melt channels, with the a^{th} level being arranged directly at the input of the melt conductor block, the c^{th} level directly at the output of the melt conductor block and the b^{th} level between the a^{th} and the c^{th} level in the designated direction of flow of the polymer melt, the melt channel of the a^{th} level is oriented towards the input as compared to the melt channels of the b^{th} and c^{th} levels. The melt channel of the c^{th} level is oriented towards the output as compared to the melt channels of the a^{th} and the b^{th} levels. Consequently, the melt channel of the b^{th} level is oriented towards the output as compared to the melt channel of the a^{th} level and on the other hand towards the input as compared to the melt channel of the c^{th} level.

By “extending three-dimensionally”, it is to be understood in the following that the multi-channel system can be formed in up to six different degrees of freedom within the melt conductor block. In other words, a melt channel of the multi-channel system can extend in portions vertically upwards and/or downwards and/or horizontally to the left and/or to the right and/or forth and/or back. Independently of how the multi-channel system within the melt conductor block is embodied, at least three of the six degrees of freedom are always used. If, for example, a melt channel of the a^{th} level which extends vertically downward is divided on one common level into two melt channels of the b^{th} level via a branching over substantially 90°, the divided melt channels extend for instance to the left or to the right in the horizontal direction, starting from the melt channel of the a^{th} level. Thus, even with such a simple subdivision of a melt channel, three degrees of freedom are already used. If, however, one of the melt channels is branched out such that at least one of the divided melt channels extends partly at an angle to the level, a fourth and/or fifth degree of freedom is used. In addition, one of the melt channels of the b^{th} level can also be partly guided in opposition to the melt channel guided vertically downward of the a^{th} level, that is, with an opposite direction of flow of the polymer melt, so that the sixth degree of freedom is used as well. Furthermore, a curved embodiment of the multi-channel system or of the melt channels and/or the further branchings in space are conceivable such that several degrees of freedom can be used simultaneously.

A “branching” or “sub-branch” according to the present invention is a nodal point at which a melt channel is divided into at least two melt channels independently of a direction of flow of a polymer melt. A sub-branch is a branch from the second level downward. In a melt distributor, a melt channel of the a^{th} level is divided into two or more melt channels of the b^{th} level via a branching. A melt channel of the b^{th} level is subsequently divided into two or more melt channels of the c^{th} level via a branching into two or more melt channels. In a melt mixer, in contrast, the branching or the sub-branches each function as junctions, with two or more melt channels of the b^{th} level being joined or combined to form a melt channel of the a^{th} level or a lower number of melt channels of the a^{th} level.

By means of a melt conductor in the form of a melt distributor, a polymer melt continuously fed into the melt distributor or multi-channel system of the melt distributor block can be distributed such over a plurality of outputs that the polymer melt can be provided at these outputs or output channels with substantially equal shear stresses. That is, the multi-channel system is preferably embodied such that the polymer melt always has a homogeneous melt history. Furthermore, it is in this manner achieved that the polymer melt is distributed particularly evenly over the output side of the melt distributor block and thus can also be provided particularly homogeneously at an extrusion space proximate to one of these output channels in a downward direction, that is, in particular at a collection space and/or an inlet of the extrusion nozzle.

The expression “equal shear stresses” according to the invention substantially describes wall shear stresses between the wall of the multi-channel system and the polymer melt conducted in the respective melt channel, in particular in all branching stages or all levels of the melt channels, the shear stresses being substantially equal or constant or nearly equal or constant and deviating from each other by less than 30%, preferably less than 20% and particularly preferably less than 10%.

By means of a melt conductor in the form of a melt mixer, a polymer melt continuously fed into the melt mixer or multi-channel system of the melt mixer block can be joined such at a lesser number of outputs that the polymer melt can be provided at this/these output(s) with substantially equal shear stresses. In this case as well, the multi-channel system is preferably embodied such that the polymer melt always has a homogeneous melt history at the output. Furthermore, it is in this manner achieved that the polymer melt is joined particularly evenly at the output side of the melt distributor block and thus can also be provided in a targeted manner at an extrusion space proximate the output channel(s) in a downward direction, that is, in particular at a collection space and/or an inlet of the extrusion nozzle.

This is mainly achieved by cross-sectional areas of the melt channels which change from one level to the next and the branchings and sub-branches, i.e. junctions, arranged between the melt channel levels.

In the case of a melt distributor, the cross-sectional area of each melt channel of one level is reduced with increasing levels and in the designated direction of flow of the polymer melt, with the sum of melt channels increasing with each ascending level so that melt flows are distributed from level to level in the designated direction of flow.

In the case of a melt mixer, the cross-sectional area of each melt channel of one level is increased with decreasing levels and in the designated direction of flow of the polymer melt, with the sum of melt channels decreasing with each descending level so that melt flows are joined from level to level in the designated direction of flow.

By a “means for at least indirectly influencing the polymer melt”, a unit, an assembly, a component and/or an element is intended which directly or indirectly influences, i.e. manipulates and/or alters, the melt stream directed into a respective melt channel of the multi-channel system.

By “at least indirectly”, it is understood that the means for influencing the polymer melt and the polymer melt conducted in the respective melt channel of the multi-channel system are (operatively) interconnected via an additional component or functional element arranged between the means for influencing and the polymer melt; or interconnected directly without an interposed component. Between the influencing means and the polymer melt, for instance a heat-conducting material can be arranged, the influencing means thus being a device for temperature control of the polymer melt. In this manner, indirect influence on the polymer melt takes place the flow properties of which are thus improved. Moreover, components or elements can be provided on or in the melt channel which achieve a mixing, acceleration and/or deceleration of the melt stream conducted through the respective melt channel, for instance ramps, braces, breaker plates, channels, static or dynamic cross-section modification means or the like. In this manner, direct influencing of the polymer melt takes place since the means arranged in or at the respective melt channel come in direct contact with the polymer melt for influencing. The respective means for at least indirectly influencing the polymer melt can be formed by means of an additive manufacturing method, either separately or during production of the melt conductor block, in particular the multi-channel system.

Preferably, a means for at least indirectly influencing the polymer melt is a static functional element, an actuator, a bimetal, a part movably arranged inside a melt channel, a pump, a replaceable plug-in element and/or a cross-section modification means for the multi-channel system.

A “static functional element” is at least one substantially stationary element or component arranged or formed on or in the multi-channel system which interacts with the designated polymer melt. The static functional element achieves an influence on the polymer melt such that the properties, in particular the flow properties, of the polymer melt substantially remain the same or are preferably improved from the input to the output. In particular, the static functional element can achieve a more homogeneous melt temperature of the melt stream. Also, deposits and/or demixing of the polymer melt in the multi-channel system can be prevented by homogenization of the melt stream.

An “actuator” is an electromechanical drive element which influences the melt stream at least indirectly, preferably directly. The actuator can be arranged on or in the respective melt channel and can mechanically influence the polymer melt conducted inside it. In particular, the actuator can be used to influence the amount of polymer over the width B of an extrusion nozzle output of an extrusion nozzle.

A “bimetal” in the sense of the invention is a component or a part of the melt conductor block operatively connected to the respective melt channel which consists of two different metals connected to each other by material and/or positive engagement. The bimetal can have, for instance, two layers of different metals arranged on top of one another. Due to the different thermal expansion coefficients of the employed metals, one of the layers expands more than the other under thermal influence, causing the bimetal to e.g. deform locally. These material properties can be used to achieve a local deformation of the local cross-section of the respective melt channel In this manner, temperature-dependent local expansion or local tapering become possible. The bimetal can preferably be also manufactured additively during production of the melt conductor block or of the multi-channel system.

Thus, the bimetal is preferably adapted to locally alter a channel geometry of at least one of the melt channels in dependence on a preferably electrically and/or fluidically induced temperature change at the melt conductor block.

A part movably arranged in the respective melt channel is an element or component arranged in such a manner in or at the melt channel that by a dynamic movement it either actively influences the polymer melt or is actuated by the polymer melt such that this results in an influencing of the polymer melt. Thus, kinetic energy of the flowing polymer melt can be transferred to the part movably arranged inside the respective melt channel. The movable part is arranged, for instance, about a rotational axis. In this case, it can be e.g. a wheel, a turbine blade and/or a flap and influence the polymer melt such that homogenization of the flow rate and of the material properties of the melt stream takes place. The rotational axis of the movably arranged part can extend coaxially with, parallel or at an incline to the longitudinal direction of the melt channel, depending on construction and arrangement of the part. Alternatively or in addition, such a part can also be movably arranged in the area or within a branching or sub-branch.

A means for at least indirectly influencing the polymer melt, which is embodied as a “pump”, is a conveying means for polymer melt which transfers energy on the polymer melt by fluidic processes. In this manner, an alteration in pressure and/or in the flow rate is achieved by the pump arranged in or at the respective melt channel.

A “replaceable plug-in element” according to the invention is a component which can at least partly be inserted in the melt conductor block and influences the polymer melt after insertion. The plug-in element can have the form of a cassette and be insertable and fixable into place in a complementary recess in the melt distributor block. The plug-in element can comprise one or more of the abovementioned means for influencing the polymer melt.

A “cross-section modification means” is an element arranged in or at the respective melt channel which locally alters the cross-section of the melt channel In other words, the cross-section modification means alters a flow rate locally either statically or dynamically. This can be done by means of a lip arranged in the melt channel, i.e. statically, or dynamically, for instance in the form of a valve which adjusts a flow rate through the respective melt channel or adapts it to requirements.

Preferably, the replaceable plug-in element is adapted to locally change a channel geometry of at least one of the melt channels and/or to fluidically connect at least two of the melt channels of the multi-channel system. In other words, the plug-in element can have melt channel portions and/or branchings so as to achieve a local junction or separation of melt channels.

Alternatively, or in addition, the local cross-section of the melt channel portions can be larger or smaller than the respective melt channel with which the plug-in element is operatively connected. Thus, by means of the plug-in element, a cross-sectional shape of the melt channel of the respective level can locally be changed, i.e. increased or reduced.

The plug-in element can be further adapted to change a geometry and structure of the multi-channel system over several levels of melt channels and/or several levels of branchings and sub-branches. Thus, by changing between two different plug-in elements, quick changes of requirements on the extrusion product can be reacted to quickly and easily.

Preferably, the melt conductor, in particular the melt conductor block, has an inspection opening with an external port to the multi-channel system. By means of such an inspection opening, the multi-channel system can be checked for any obstructions or deposits. Moreover, flushing or cleaning of the multi-channel system can be performed or supported by means of the inspection opening. The inspection opening is sealable such that during operation of the extrusion facility, undesirable influencing of the polymer melt via the inspection opening is prevented.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged with three-dimensional extension inside the melt conductor block, the melt conductor, in particular the melt conductor block, having an inspection opening to the multi-channel system.

Further preferably, the melt conductor, in particular the melt conductor block, has a valve seat with an external port to the multi-channel system. The external port can be a separate port or integrated in the inspection opening. The valve seat is arranged at the respective melt channel and can be formed as a cavity for receiving a valve. Alternatively or in addition, the valve seat can be formed so that receiving a filter unit, for instance to filter suspended particles from the polymer melt, is possible. The filter unit can in turn comprise a filter element accessible via the external port or the inspection opening, respectively.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged so as to extend three-dimensionally inside the melt conductor block, the melt conductor, in particular the melt conductor block, having a valve seat with an external access to the multi-channel system.

In one embodiment, the melt conductor, in particular the melt conductor block, has a through opening with an external access to the multi-channel system by means of which a medium can be directed toward or away from the multi-channel system. The through opening can be a separate channel to a respective melt channel or part of the inspection opening. Moreover, the through opening can be a separate channel system for access to several melt channels of one or more levels. The medium can be a liquid or a gas, which liquid may also have solid components.

The through opening is optionally adapted to deviate air from the multi-channel system or direct air to the multi-channel system. Consequently, the through opening is adapted for airing and/or venting the multi-channel system.

It is further conceivable to feed a fluid to the melt stream so that the polymer melt reacts with the fluid and the material properties of the polymer melt change accordingly.

Alternatively, or in addition, the through opening is adapted for supplying an additive to at least one melt channel of the multi-channel system. Thus, it is conceivable that the through opening is part of the inspection opening. Supplying an additive via the respective through opening is relevant especially if compounding is to take place, wherein at least one additive is added to the polymer melt for manufacturing of the extrusion product. An additive is advantageous for adapting the material properties of the finished plastic material to the requirements of the application or to influence the material properties of the polymer melt during processing. In addition, additives in the plastic may sometimes improve the chemical, mechanical and/or electrical properties of the compound. Additives are, in particular, plasticizers, stabilizers, reinforcing agents, coloring or filling agents as well as propellants or lubricants. It is also conceivable to supply a marker as an additive through the through opening, by means of which an extrusion product can be, for instance, identified, read and/or authenticated. It is also possible to combine or mix, respectively, the additives mentioned here as desired.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged so as to extend three-dimensionally inside the melt conductor block, the melt conductor, in particular the melt conductor block, having a through opening with an external access to the multi-channel system by means of which a medium can be directed towards or away from a multi-channel system.

Preferably, a means of at least indirectly influencing the polymer melt is a manipulating device for manipulating melting areas arranged inside the melt conductor block for conducting polymer melt, which manipulating device can be selectively and alternately activated and deactivated.

“Melting areas” are intended to be all portions of the multi-channel system directing polymer melt; that is, the input, the melt channels of all levels, all branchings and sub-branches as well as the respective output.

The manipulating device can be switched on and off depending on the operating situation of the extrusion facility. Therefore, it can be connected to a control unit or computer unit which initiates and performs an activation or deactivation. In several manipulating devices, it is possible to locally or in certain areas influence the polymer melt in the multi-channel system. In other words, each manipulating device is only operatively connected to individual melt areas or segments of the melt conductor block in this case.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged so as to extend three-dimensionally inside the melt conductor block, the melt conductor, in particular the melt conductor block, having a manipulating device for manipulating melting areas arranged inside the melt conductor block to conduct polymer melt which can selectively and alternately be activated and deactivated.

In one example of embodiment, the manipulating device is embodied to be temperature-controlled. In other words, the manipulating device comprises a temperature control element and/or a temperature control strip which can be arranged in or on the respective melting area. Advantageously, the temperature control element or temperature control strip is adapted to control the temperature of a material surrounding and forming the multi-channel system, which material in turn influences the temperature of the polymer melt inside the multi-channel system. The temperature control element can locally influence the polymer melt whereas the temperature strip can be arranged, for instance, circumferential around the respective melt channel and/or along its longitudinal extension so as to accordingly influence the polymer melt temperature.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged so as to extend three-dimensionally inside the melt conductor block, the melt conductor, in particular the melt conductor block, having a temperature-controlled manipulating device for manipulating melt areas arranged inside the melt conductor block for conducting polymer melt, which device can be selectively and alternately activated and deactivated.

Preferably, the melt conductor block further has a medium channel, in particular for a circulating fluid supply, especially for temperature control and/or for an electric line and/or a measuring unit.

A “medium channel” in this context is intended to mean an additional channel system formed fluidically separate from the multi-channel system, which can have the same basic structure as the latter. This means that the medium channel as well can extend three-dimensionally through the melt conductor block and has an input as well as an output fluidically connected therewith. The medium channel is arranged spaced between the melt channels of the multi-channel system and can be operatively connected to the latter. It can be formed for conducting a medium, in particular a temperature control medium. Other than the hollow chamber system, the medium channel is a separate channel formed so as to save space or a separate channel system by means of which an interaction with the polymer melt conducted in the melt channels can be achieved. In addition, the medium channel or another medium channel can be provided for conducting electrical lines and/or a measuring unit, for instance a sensor system with its electrical supply line. Due to additive manufacturing thereof, the multi-channel system can be guided around the medium channel, which can be additively manufactured as well, or vice versa. The supporting structures described above can also be used for providing static stability of the medium channel.

It is explicitly pointed out that a device having the features of the above paragraphs in itself represents an independent aspect of the invention, independently of the independent Claim described above. A combination of features, understood to be disclosed independently and advantageously, would therefore be the following:

Melt conductor, in particular melt distributor or melt mixer, for an extruding die of an extrusion facility, having a melt conductor block with a multi-channel system, the multi-channel system being arranged so as to extend three-dimensionally inside the melt conductor block, the melt conductor, in particular the melt conductor block, having a medium channel arranged spatially between melt channels of the multi-channel system, in particular for a circulating fluid supply, especially for temperature control, and/or for an electrical line and/or a measuring unit.

In one embodiment, the static functional element is a static mixing element. The static mixing element is preferably arranged inside the multi-channel system or in a melt channel of the multi-channel system and is preferably manufactured, with additive manufacturing of the multi-channel system, at least partially by additive manufacturing as well. The mixing element can be ramp-shaped, rod-shaped, curved or the like and is mainly designed for mixing and homogenizing the designated polymer melt. Due to the shear stresses inside the polymer melt, the melt stream has different flow rates in the melt channel, which decrease from a central axis of the melt channel in the direction of the melt channel wall. The static functional element, in particular the static mixing element, in this context homogenizes the melt strand conducted inside the melt channel. For instance, directly before an output of the multi-channel system, homogenization of the melt flow through a static mixing element can achieve homogeneous feeding of an extrusion nozzle or of a collection chamber arranged upstream of the extrusion nozzle.

The static mixing element is preferably arranged inside the melt channel between two branchings or sub-branches. It is conceivable that in the area of the mixing element, a minor local change in cross-section of the melt channel is formed, especially for improving a mixing effect. Preferably, a local widening of the melt channel is provided which is formed in dependence on the flow characteristics inside the respective melt channel, the static mixer being formed inside the local widening portion. The melt channel preferably has substantially the same cross-sectional size and shape before and after the local widening portion of the melt channel, a locally enlarged cross-section being formed therebetween in the designated direction of flow of the polymer melt. The change in cross-section can be step-shaped and/or ramp-shaped. Furthermore, it is advantageous if after a change in direction of the melt channel, the polymer melt or the melt flow, respectively, is directed from the central axis of the respective melt channel in the direction of the wall of the melt channel by a simple static mixing element.

It is explicitly pointed out that a device having the features in the above paragraphs, even taken by itself, represents an independent aspect of the invention, independently of the independent Claim described above. An independent, advantageous disclosed combination of features would therefore be the following:

Melt conductor, in particular melt distributor or melt mixer, for an extruding die of an extrusion facility, having a melt conductor block with a multi-channel system, the multi-channel system extending three-dimensionally inside the melt conductor block, the melt conductor, in particular the melt conductor block, having a static mixing element.

The invention includes the technical teaching that the melt conductor block has a first multi-channel system and a second multi-channel system and in particular a third, fourth or fifth multi-channel system. The multi-channel systems can extend fluidically separated or at least two multi-channel systems can be joined so as to mix the polymer melts of the joined multi-channel system. More than five multi-channel systems are conceivable as well which are at least partly formed by means of an additive manufacturing method within the melt conductor block. The different multi-channel systems can conduct identical, but also different or partly identical and partly different polymer melts so as to produce, for instance, multi-layer or at least partly overlapping film webs or filaments. In addition, with regard to material requirements and properties, different polymer melts can be conducted in the multi-channel systems, in particular joined and distributed so as to produce an extrusion product. It is also possible to produce individual filaments from polymer melts of different multi-channel systems. Filaments can be formed from different components, i.e. polymer melts with various mixing ratios, the components being arranged, for instance, adjacent to one another, in layers, sheets and/or segments in the respective filament.

From a plurality of filaments, non-woven fabrics with equal or different material properties can be produced. A non-woven fabric consists of a plurality of individual filaments, preferably 20 to 10,000 individual filaments per meter width of the fabric. The outputs of the respective multi-channel system can be formed for atomization of the polymer melt to form one filament. It is also possible that the extrusion nozzle downstream of the melt conductor block is adapted for producing the filaments and then of the non-woven fabric.

In a second aspect of the invention, the task is solved by an extruding die for an extrusion facility for the production of extrusion products, comprising a melt conductor according to the embodiment described above, the melt conductor being adapted for distributing and/or mixing at least one polymer melt.

An “extruding die” is an assembly of an extrusion facility comprising one or more melt conductors with one or more melt conductor blocks each. The extruding die is fed with polymer melt which is at least indirectly conducted into the melt conductor or a multi-channel system of a melt conductor block of the melt conductor. Upstream of the extruding die, a provision unit in the form of an extruder or the like is arranged for providing the designated polymer melt. Downstream of the melt conductor or of the respective melt conductor block, preferably at least one extrusion nozzle is arranged which may be part of the extruding die as well. The extrusion nozzle in turn has an extrusion nozzle output which is embodied for intermediate forming or final forming of the extrusion product.

Alternatively, the respective melt conductor block can already comprise an extrusion nozzle integrally connected to it, or it can be formed as an extrusion nozzle or assume the functions of an extrusion nozzle such that a separate extrusion nozzle becomes unnecessary. For this purpose, the respective output of the multi-channel system on the output side of the melt conductor block is accordingly formed and dimensioned such that atomization of the designated polymer melt takes place. In this case, the sum of all outputs on the melt conductor block is called “extrusion nozzle output”, where the extrusion nozzle output can be embodied as desired depending on the arrangement of the outputs with respect to each other in terms of height and width. The extrusion nozzle output preferably has a width many times larger than its height.

Like the melt conductor, the separate extrusion nozzle and correspondingly also the extrusion nozzle output can at least partly be produced by means of an additive manufacturing method. Such an additive manufacturing method is a particularly uncomplicated way of producing various geometries of the extrusion nozzle and the extrusion nozzle output as well as respective connecting means for positively and frictionally connecting the extrusion nozzle to the melt conductor.

The extrusion nozzle of the extruding die preferably has a width of more than 5,000 mm, preferably more than 6,000 mm or more than 8,000 mm By at least partially additive manufacturing of the extruding die, in particular the extrusion nozzle output, dimensions can be achieved which have not been possible up to now. In particular, the extrusion nozzle and the extrusion nozzle output can be over-dimensioned. In addition, worn or defective parts can be replaced faster. Moreover, the extrusion nozzle and/or the extrusion nozzle output can be multipart, which allows in particular precisely fitting components with low tolerances.

In a third aspect of the invention, the task is solved by an extrusion facility for manufacturing extrusion products, comprising an extruding die of the type described above. The extrusion facility is in particular provided for processing polymer melts and for manufacturing extrusion products. The extrusion facility is fed with polymer melt by a provision unit comprising a silo and/or an extruder or the like. The advantage of such an extruding die is that due to the manufacturing method thereof, a particularly quick an easy replacement of the melt conductor, the melt conductor block, any extrusion nozzle present and/or any extrusion nozzle output present at the nozzle, for instance for repair and/or maintenance purposes, is possible. In addition, extrusion products can be manufactured in oversize, especially in overwidth, since the extruding die can have any desired shape and size, in particular any width. Moreover, a multipart embodiment of the melt conductor with several melt conductor blocks switched in parallel or in series is possible for manufacturing extrusion products with dimensions which have not been possible up to now, especially in overwidth.

The extrusion facility with the melt conductor according to the invention can be embodied as a device for manufacturing filaments or fibers. Such devices have a dot-shaped polymer melt output at the extruding die or at the melt conductor block of the melt conductor in common, several small nozzle bores being formed on the output side. As endless filaments, the fibers form, for instance, nonwoven fabrics, mono- or multi-filaments or small tapes. During this process, the melt conductor according to the invention is advantageously employed as a melt distributor of the shaping extruding die for distributing the polymer melt.

In particular, the melt conductor according to the invention can be employed in a device for manufacturing non-woven fabrics made of endless filaments (called a spunbound line), substantially consisting of a spinning device for spinning filaments, a cooling device for cooling the filaments, a stretching device for stretching the filaments, a depositing unit, in particular a deposit filter belt, for depositing the filaments to form a non-woven web, a solidification unit for solidifying the filaments of the non-woven web and a winding unit for winding the non-woven web.

The spinning device substantially consists of at least one gravimetric or volumetric dosing unit for dosing and feeding at least one polymer component to an extruder or to a provision unit, at least one extruder or one provision unit for compacting, melting and conveying the at least one polymer component, at least one melt filter ideally acting as a screen changer with or without automatic cleaning for filtering particles from the polymer melt, at least one melt and/or viscose pump for conveying the polymer melt, at least one melt conductor in the form of a melt distributor which distributes the polymer melt substantially transversely to the global machine direction, i.e. in “cross direction” (CD) of the device, possibly at least one additional melt conductor embodied as a melt distributor which additionally distributes the polymer melt transversely to the global machine direction, but also perpendicularly to the “cross direction” (CD) in what is called a “machine direction” (MD) of the device, a one- or multipart nozzle die of the extruding die for producing filaments from polymer melt and rigid and/or flexible tubings for connecting the abovementioned units. The melt conductor according to the invention is in particular employed as a melt distributor for distributing the polymer melt.

The invention can also be used in a device for manufacturing non-woven fabrics consisting of ultrafine endless filaments (called a melt blowing plant), substantially consisting of at least one blowing unit for producing and subsequently cooling ultrafine filaments, a depositing unit, in particular a depositing roller, for depositing the ultrafine filaments to form a non-woven web, a solidification device for depositing the filaments to form a non-woven web and a winding device for winding the non-woven web.

The spinning device substantially consists of at least one gravimetric or volumetric dosing unit for dosing and feeding at least one polymer component to an extruder or to a provision unit, at least one extruder or one provision unit for compacting and melting the at least one polymer component, at least one melt filter ideally acting as a screen changer with or without automatic cleaning for filtering particles from the polymer melt, at least one melt and/or viscose pump for building up continuous pressure on the polymer melt, at least one melt conductor formed as a melt distributor evenly distributing the polymer melt in the “cross direction” (CD) of the device, possibly at least one additional melt conductor embodied as a melt distributor which additionally distributes the polymer melt in the “machine direction” (MD) of the device, a one- or multipart nozzle die of the extruding die for producing ultrafine filaments from polymer melt and rigid and/or flexible tubings for connecting the abovementioned units. The melt conductor according to the invention is in particular employed as a melt distributor for distributing the polymer melt.

In another variant, the extrusion facility according to the invention with the melt conductor according to the invention can be a device for manufacturing plates or flat films. Such devices have in common that a linear polymer melt output is formed at the extruding die, in particular at the melt conductor block of the melt conductor, causing the extrusion product to have at least one upper and one lower face. The melt conductor is advantageously employed as a melt distributor of the shaping extruding die for distributing the polymer melt.

In a further embodiment, the melt conductor according to the invention can be employed in a device for manufacturing flat films (called a flat-film line), comprising a unit for providing a polymer melt, a slot die or a die for producing a plate-shaped polymer melt stream and a cooling roller unit.

The unit for providing a polymer melt consists of at least one gravimetric or volumetric dosing unit for dosing and feeding at least one polymer component to an extruder, at least an extruder for compacting, melting and conveying the at least one polymer component, at least one melt filter ideally acting as a screen changer with or without automatic cleaning for filtering particles from the polymer melt, optionally a melt and/or viscose pump for conveying the polymer melt, optionally a melt mixer for creating a multi-layered structure of the melt stream, a melt conductor embodied as a melt distributor for distributing the melt stream in the “cross direction” (CD), an extrusion nozzle formed as a slot die for forming a plate-shaped polymer melt stream and rigid and/or flexible tubings for connecting the abovementioned units. The melt conductor can be embodied as a melt distributor, a melt mixer or a combination of both.

In another variant, the extrusion facility according to the invention with the melt conductor according to the invention can be embodied as a device for manufacturing pipes, profiles or tubings. Such devices provide for a polymer melt output which produces interior and exterior surfaces of the extrusion product by a correspondingly shaped melt channel guide and/or supplementary installations. Advantageously, the melt conductor according to the invention is employed as melt distributor of the shaping extruding die for distributing the polymer melt.

In another variant, the extrusion facility according to the invention with the melt conductor according to the invention can be embodied as a device for manufacturing a tubular film. Such a device has an at least partly circular polymer melt output at the extruding die which comprises an annular gap, providing the extrusion product with an inner and an outer face. The melt conductor according to the invention is advantageously employed as a melt distributor of the shaping extruding die for distributing the polymer melt.

In particular, the melt conductor according to the invention can be employed in a device for manufacturing blown films (called a blow-molding plant), substantially consisting of a unit for providing a polymer melt, i.e. a provision unit, a blowing head for producing a tubular film, a take-off unit for taking off and stretching the tubular film in the transverse and longitudinal extrusion directions and a cooling unit for cooling the tubular film.

The unit for providing a polymer melt, i.e. the provision unit, substantially consists of at least one gravimetric or volumetric dosing unit for dosing and feeding at least one polymer component to an extruder, at least one extruder for compacting, melting and conveying the at least one polymer component, at least one melt filter ideally acting as a screen changer with or without automatic cleaning for filtering particles from the polymer melt, optionally a melt and/or viscose pump for conveying the polymer melt and rigid and/or flexible tubings for connecting the abovementioned units and the blowing head, where at least the blowing head is to be understood as an extruding die according to the invention with a melt distributor, in particular a spiral or plate distributor, integrated in the blowing head; the blowing head comprising a slot die with spiral distributor, in particular a radial spiral distributor for forming a one- or multilayered annular polymer melt stream as well as an inflation unit for inflating a tubular film. The melt conductor according to the invention is thus in particular employed as a melt distributor for distributing the polymer melt.

In a fourth aspect of the invention, the task is solved by a method of operating an extrusion facility according to the embodiment described above, the extrusion facility being fed at least one extrudible polymer, in particular at least one plastic, which is plasticized to form a respective polymer melt, the polymer melt being fed to a melt conductor of the type described above which distributes and/or mixes the polymer melt.

Feeding of the extrudible polymer takes place, for instance, via a silo or a conveying unit which is either part of the extrusion facility or a separate component or assembly. The extrudible polymer can be fed to the extrusion facility as a granulate, that is, in substantially solid form, or as an at least partially molten melt.

After being fed into the extrusion facility, granulate can be processed by a provision unit, in particular an extruder or the like, and plasticized by melting and/or additional processing steps such that it can be fed to the melt conductor as a polymer melt for combination and/or separation. After separation and/or combination, the polymer melt can be fed from the melt conductor to an extrusion nozzle which further processes the polymer melt to obtain the extrusion product.

It is an advantage of such a facility that with such an extruding die, it can be operated much more economically since product change times are much shorter with a change of polymer and the overall operating time of the extruding die before die cleaning are substantially longer. Thus, flushing times are optimized.

All components of the extrusion facility which are described within the framework of this invention as additively manufactured components, in particular the extruding die, the melt conductor and the melt conductor block, are formed from a material suitable for additive manufacturing and/or casting. Particularly suited materials are metal, plastics and/or ceramics. By “plastics”, preferably high-performance plastics are intended which allow for operating temperatures of the extruding die of more than 200° C. An advantage of components additively manufactured from ceramics, in particular melt channels additively manufactured from ceramics, is the minimization of deposits. Advantageously, the surfaces of the melt channels which come in direct contact with the polymer melt are formed as one- or multilayer ceramic sheets in the form of inliners, from a material which differs from the already available melt conductor block. In other words, portions of the channels of the respective multi-channel system can have a one- or multi-layer ceramic sheet for channel-surface modification. It is also conceivable, however, to form the entire melt conductor block partly or entirely from ceramics. In other words, different segments of the melt conductor block with the multi-channel system can consist of different materials whose advantages can be exploited for the respective application case. They can in particular be different metals or a combination of metal, ceramics and/or plastics.

Depending on the material of the melt conductor block and/or the channels of the multi-channel system, alternatively a surface treatment for finishing the surface of the channels of the multi-channel system can take place. It can comprise a heat treatment, a chemical vapor-phase deposit, a physical vapor-phase deposit, an infiltration or the like. In this manner, a coating with one or more layers, in particular on the channel surfaces of the multi-channel system, is formed, influencing the surface condition of the channels, so that advantageously flow properties of the polymer melt are improved and deposits within the multi-channel system reduced.

After manufacturing of the melt conductor block, the inner surface of the channels of the multi-channel system and the coating of the channels, if any, can be subjected to finishing treatment. This may comprise cleaning and/or flushing of the multi-channel system. Flow grinding of the channels is possible as well. These steps can also be performed in maintenance intervals or in case of a change of product so as to detach and remove any deposits in the multi-channel system.

Naturally, features of the solutions described above or in the Claims can also be combined, if desired, so as to cumulatively achieve the advantages and effects which are achievable in this case.

Other features, effects and advantages of the present invention are described by means of the figure and the following specification in which a continuously polymer-processing extrusion facility and examples of embodiment of different melt conductors are presented and described by way of example.

Components which at least substantially have the same functions can be indicated by the same reference numbers in the individual figures; where the components are not necessarily referenced and explained in every single figure.

In the drawings:

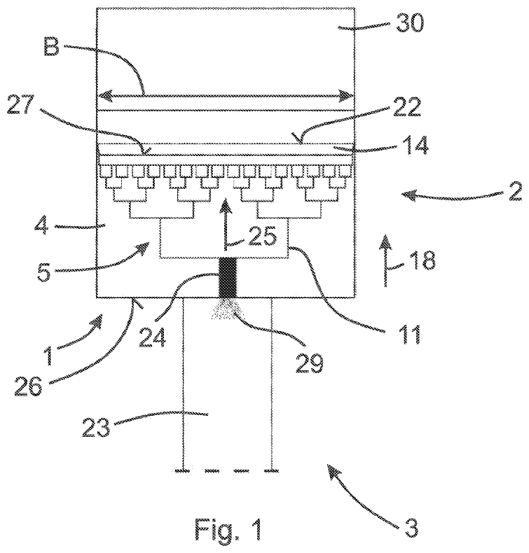

FIG. 1 is a schematic view of a possible structure of an extrusion facility having a melt conductor comprising a melt conductor block and a multi-channel system according to a first alternative;

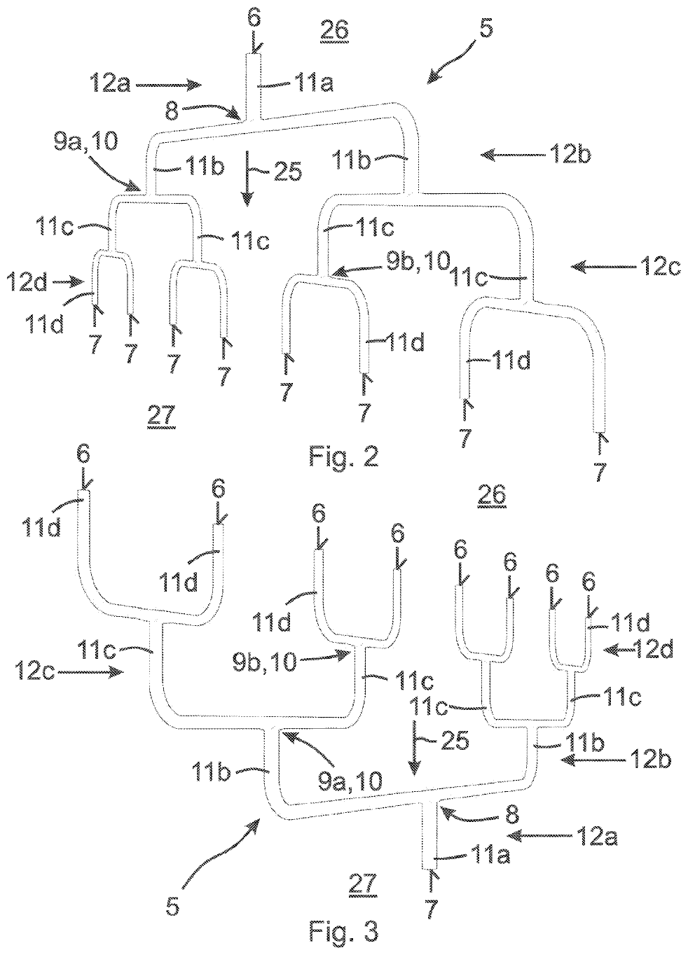

FIG. 2 is a schematic perspective view of the multi-channel system according to FIG. 1, the melt conductor being embodied as a melt distributor;

FIG. 3 is a schematic perspective view of a second alternative embodiment of the multi-channel system, the melt conductor being embodied as a melt mixer;

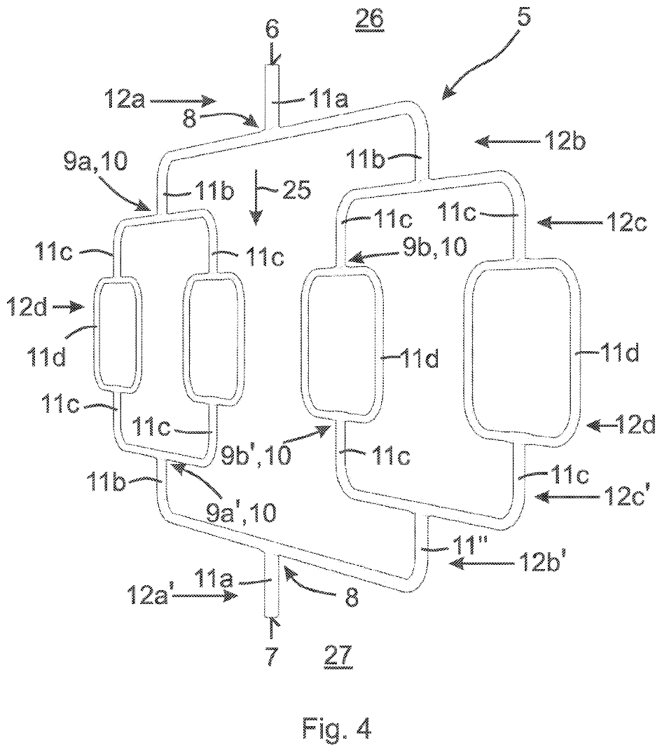

FIG. 4 is a schematic perspective view of a third alternative embodiment of the multi-channel system, the melt conductor being partly embodied as a melt distributor and partly as a melt mixer;

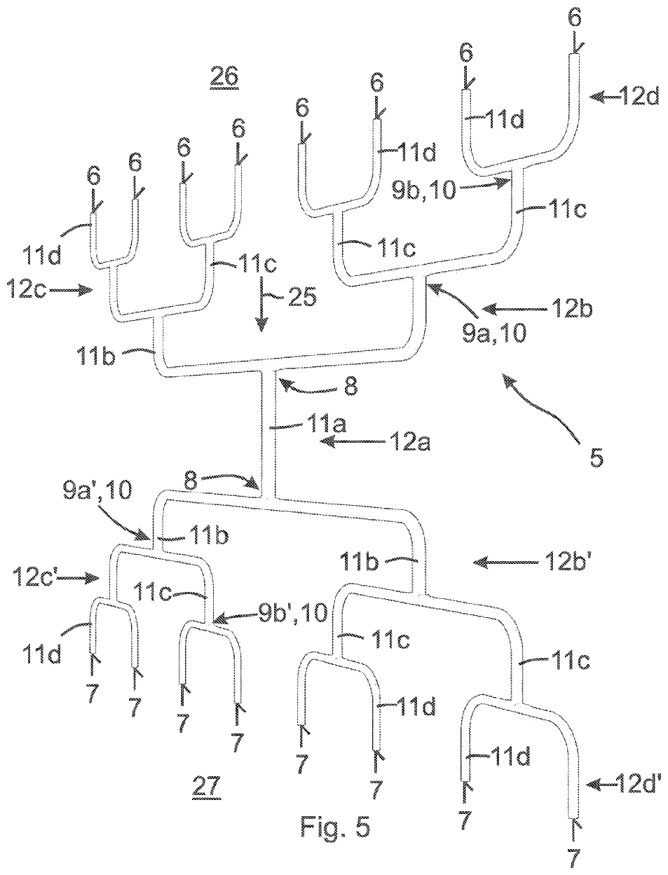

FIG. 5 is a schematic perspective view of a fourth alternative embodiment of the multi-channel system, the melt conductor being partly embodied as a melt mixer and partly as a melt distributor;

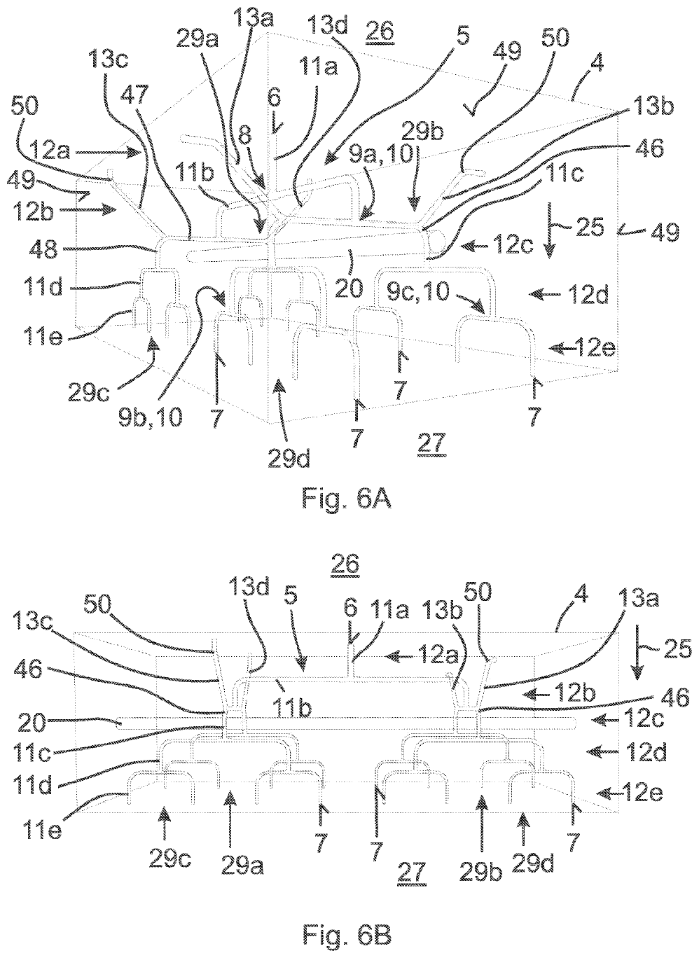

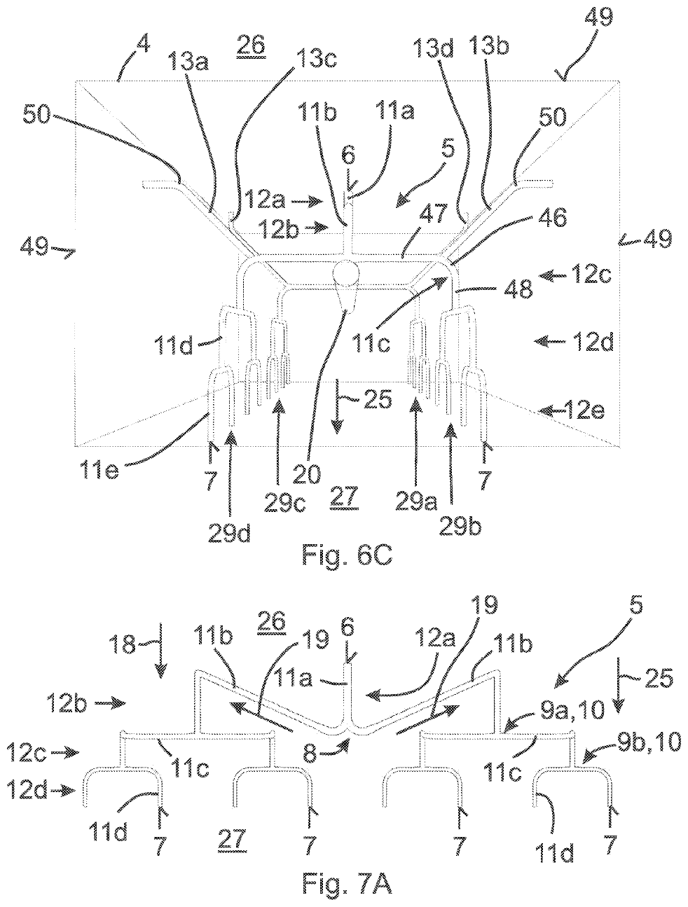

FIG. 6A is a schematic perspective view of a fifth alternative embodiment of the multi-channel system, the melt conductor being embodied as a melt distributor;

FIG. 6B is another schematic perspective view of the fifth alternative embodiment according to FIG. 6A;

FIG. 6C is a further schematic perspective view of the fifth alternative embodiment according to FIGS. 6A and 6B;

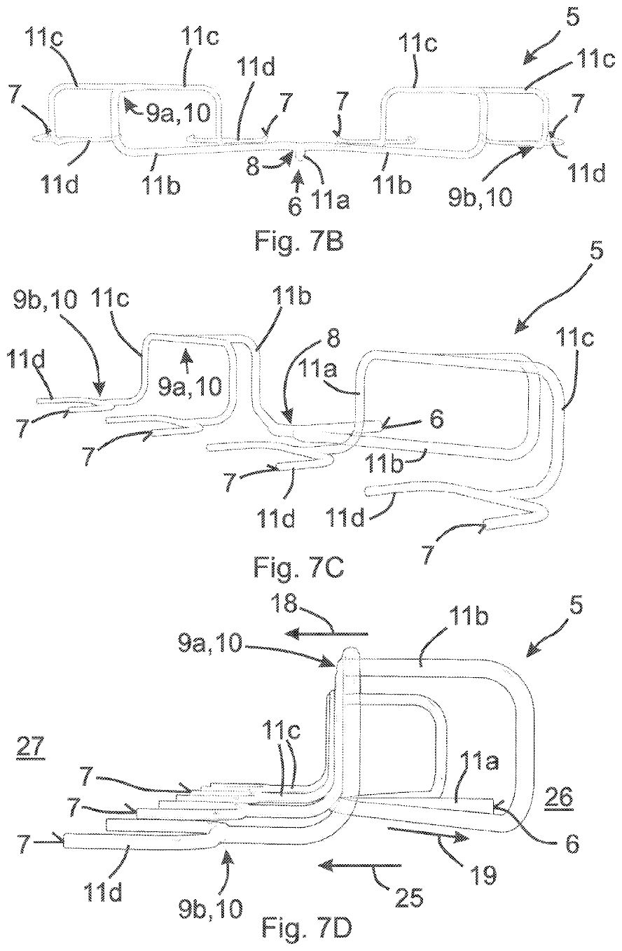

FIG. 7A is a schematic top view of a sixth alternative embodiment of the multi-channel system, the melt conductor being embodied as a melt distributor;

FIG. 7B is a schematic perspective view of the sixth alternative embodiment according to FIG. 7A;

FIG. 7C is another schematic perspective view of the sixth alternative embodiment according to FIGS. 7A and 7B;

FIG. 7D is a further schematic perspective view of the sixth alternative embodiment according to FIGS. 7A through 7C;

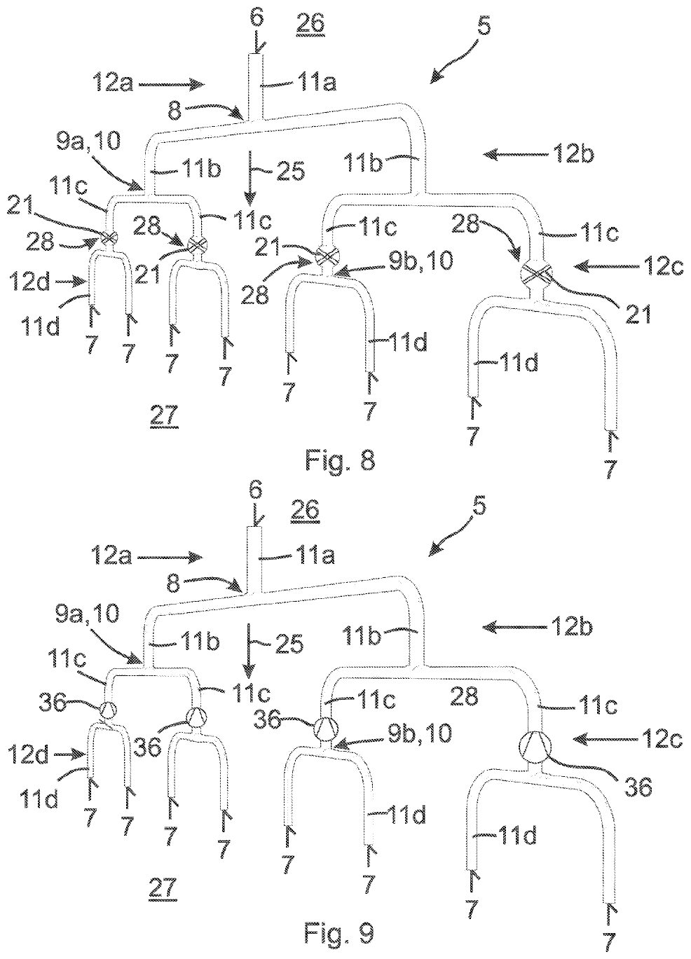

FIG. 8 is a schematic perspective view of a seventh alternative embodiment of the multi-channel system, with the melt conductor being embodied as a melt distributor;

FIG. 9 is a schematic perspective view of an eighth alternative embodiment of the multi-channel system, with the melt conductor being embodied as a melt distributor;

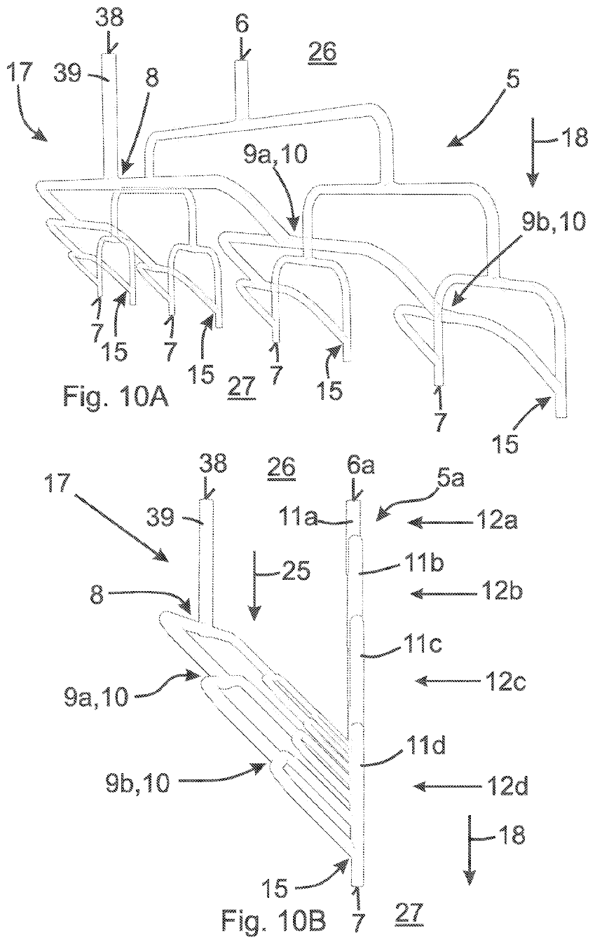

FIG. 10A is a schematic perspective view of a ninth alternative embodiment of the multi-channel system, the melt conductor being embodied as a melt distributor;

FIG. 10B is a schematic top view of the ninth alternative embodiment in FIG. 10A;

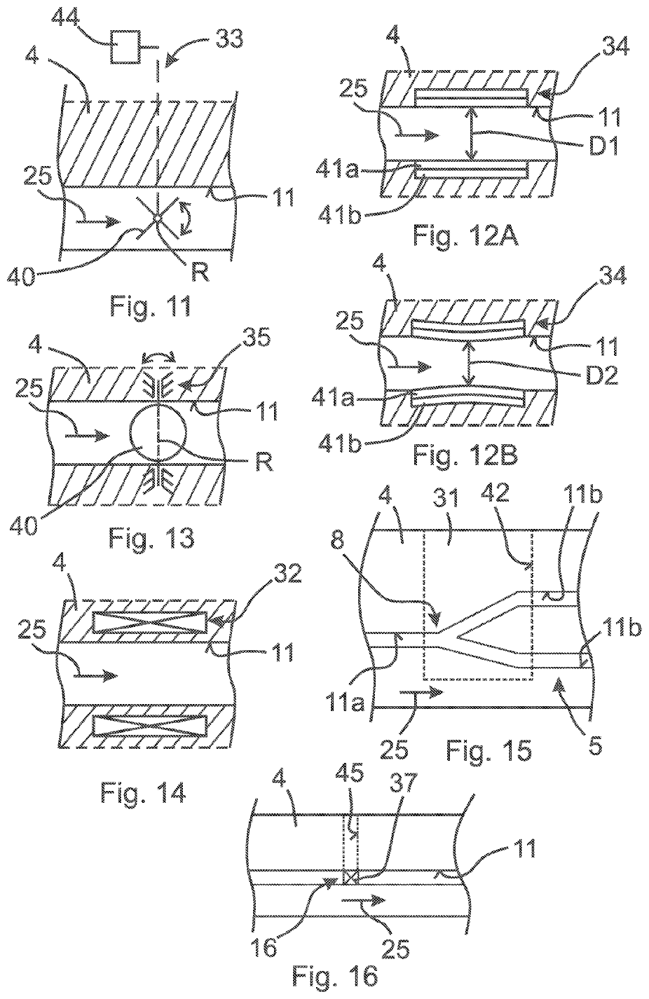

FIG. 11 is a schematic partial sectional view of a tenth alternative embodiment of a multi-channel system;

FIG. 12A is a schematic partial sectional view of a melt channel of a multi-channel system in an eleventh alternative embodiment, a bimetal being shown in a non-deformed state;

FIG. 12B is a schematic partial sectional view of the melt channel in FIG. 12A, the bimetal being shown in a deformed state;

FIG. 13 is a schematic partial sectional view of a melt channel of a multi-channel system according to a twelfth alternative embodiment;

FIG. 14 is a schematic partial sectional view of a melt channel of a multi-channel system according to a thirteenth alternative embodiment;

FIG. 15 is a schematic partial sectional view of a the melt conductor block according to a fourteenth alternative embodiment; and

FIG. 16 is a schematic partial sectional view of the melt conductor block according to a fifteenth alternative embodiment.

FIG. 1 is a strongly simplified presentation of an extrusion facility 3. The extrusion facility 3 comprises a provision unit 23 adapted to provide and process a polymer melt 24, in the present case a plastic material. The provision unit 23 is presently the extruder (not presented in detail here) which plasticizes at least one extrudible polymer 29 to form the polymer melt 24. The provision unit 23 can also be adapted for providing one or more different polymer melts 24 with the same or with different properties. The polymer melt 24 is continuously fed by the provision unit 23 into an extruding die 2, comprising a melt conductor 1 and an extrusion nozzle 14 downstream in the designated direction of flow 25 of the polymer melt 24. The extruding die 2 is integrated in the continuously operating extrusion facility 3 in which the polymer melt 24 is continuously conveyed through the melt conductor 1 in a global machine direction 18, the expressions “downstream” and “upstream” referring to this global machine direction 18.

The melt conductor 1 which is adapted as a melt distributor in this first example of embodiment has a melt conductor block 4 with a multi-channel system 5 which extends three-dimensionally inside the melt conductor block 4. The melt conductor block 4 is manufactured by means of an additive manufacturing method like the multi-channel system 5 and can be integrated in the continuously operating extrusion facility 3 as a replaceable component of the melt conductor 1. The multi-channel system 5 according to the first embodiment in FIG. 1 is represented in detail in FIG. 2A. The melt conductor block 4 can be formed massively as a block or delicately with supporting structures. In this case, the multi-channel system 5 is supported by supporting structures arranged spatially around the multi-channel system 5, which are not shown here.

The provision unit 23 is flanged to an input side 26 of the melt conductor block 4, the extrusion nozzle 14 being formed at the output side 27 of the melt conductor block 4 such that also the extrusion nozzle 14 is manufactured with an additive manufacturing method, namely together with the melt conductor block 4. On the output side 27 of the melt conductor block 4, depending on requirements on the extrusion facility 3, the extrusion product 30 and the extrusion nozzle 14, a collection chamber—not shown here—can be formed into which the multi-channel system 5 opens, the collection chamber being adapted to receive the polymer melt 24 distributed by the melt conductor 1 embodied as a melt distributor and to feed it continuously to the extrusion nozzle 14. The collection chamber can also be embodied such that a breaker plate and/or a filter sieve is integrated in it. As can be seen in FIGS. 2 through 10B, the multi-channel system 5 has one or more outputs 7 adapted to direct the polymer melt 24 for feeding the extrusion nozzle 14 into the collection chamber or directly into the extrusion nozzle. The extrusion nozzle 14 shown in FIG. 1 has an extrusion nozzle output 22 with a width B of more than 5,000 mm The width B defines the width of an extrusion product 30 manufactured by the extrusion facility, which in FIG. 1 is embodied as a film.

The melt distributor 1 distributes the polymer melt 24 according to FIG. 2 in the multi-channel system 5, with respect to its designated direction 25 of flow, from an input 6, arranged at an input side 26 of the melt conductor block 4, which in this case is embodied as a melt distributor block, via several branchings 8 arranged in series, several levels 9a, 9b of sub-branches 10 and several interposed levels of divided melt channels 11 to a plurality of outputs 7 fluidically connected to the input 6 and arranged on an output side 27 of the melt conductor block 4. Thus, the multi-channel system 5 has an input 6 and a plurality of outputs 7 fluidically connected to the input 6. The input 6 on the input side 26 of the melt conductor block 4 is consequently embodied as an input opening through which the polymer melt 24 is fed into the multi-channel system 5 of the melt conductor block 4.

For simplification purposes, the multi-channel system 5 in FIG. 2A is only shown with one branching 8 and two levels 9a, 9b of sub-branches 10. The other sub-branches 10 and melt channels are substantially formed in an analogous manner to distribute the polymer melt 24 over the respective width B of the extrusion nozzle output 22. Thus, three or more levels of sub-branches 10 are possible as well. In the designated direction 25 of flow of the polymer melt 24, a melt channel 11a of the a^{th} level 12a is arranged between the input 6 and the branching 8, sub-branches 10 of a b^{th} level 12b of melt channels 11b between the branching 8 and the first level 9a, and sub-branches 10 of a c^{th} level 12c of melt channels 11c between the first level 9a of sub-branches 10 and the second level 9b of sub-branches 10. The second level 9b of sub-branches 10 is also followed by a d^{th} level 12d of melt channels 11d. FIG. 2A also shows that the number of melt channels 11 increases with each level; that is, one melt channel 11a of the a^{th} level divides into two melt channels 11b of the b^{th} level; the two melt channels 11b of the b^{th} level in turn each divide into two melt channels 11c of the c^{th} level; i.e. in total four melt channels 11c are formed, etcetera. In other words, the number of melt channels 11 doubles from one level to the subsequent level in the direction 25 of flow. Therefore, also the multi-channel system 5 and its individual cavities in the form of melt channels 11, branching 8 and sub-branches 10 are manufactured by the additive manufacturing method. Furthermore, additional cavities can be provided e.g. in the form of a collection chamber, local expansions 28 or junctions which will be explained in more detail in the further description of alternative embodiments. Also, the cavities can be embodied as distribution or mixing chambers (not shown here) or the like.

In this embodiment, the melt channel 11a of the a^{th} level 12a has a first local cross-section smaller than the second local cross-section of the divided melt channels 11b of the b^{th} level 12b. Every local cross-section of the divided melt channels 11b of the b^{th} level 12b is again larger than the local cross-section of the divided melt channels 11c of the c^{th} level 12c etcetera.

When smaller or larger local cross-sections of the respective melt channel 11 are mentioned, this means that the melt channel 11 has a larger or smaller cross-section, respectively, over at least half the length of the respective melt channel 11, preferably at least ⅔ the length of the respective melt channel 11, preferably at least ¾ the length of the respective melt channel 11.

Here, the melt channel 11a of the a^{th} level 12a is oriented towards the input 6 in the designated direction 25 of flow of the polymer melt 24 and the melt channels 11b of the b^{th} level 12b are oriented towards the output 7 with respect to the melt channel 11a of the a^{th} level 12a. The melt channels 11c of the c^{th} level 12c are oriented towards the input 6 with respect to the melt channels 11d of the d^{th} level 12d, the melt channels 11d of the d^{th} level 12d being oriented towards the output 7 with respect to the melt channels 11 of the a^{th}, b^{th} and c^{th} levels 12a, 12b, 12c. Accordingly, the melt conductor 1 acts as a melt distributor.

In FIG. 3, a second alternative multi-channel system 5 of a second alternative melt conductor block 4, which is not shown here, the melt conductor 1 is, in contrast to FIG. 2, arranged in reverse order in the extruding die 2 and the extrusion facility 3 and is consequently embodied as a melt mixer in this alternative example of embodiment. This is due to the fact that the melt conductor 1 has a plurality of inputs 6, eight in this case, on the input side 26 of the melt conductor bock 4 via which one or up to eight identical or at least partly different polymer melts 24 are combined into an output 7 fluidically connected to the inputs 6 and arranged on the output side 27 of the melt conductor block 4. In the present case, the melt conductor block 4 is not shown but only, for better clarity, the multi-channel system 5. The multi-channel system 5 is formed substantially identical with the embodiment in FIG. 2. The only difference is that the polymer melt 24 is not distributed through the multi-channel system 5 but that up to eight different polymer melts 24 can be combined by means of the multi-channel system 5. The multi-channel system 5 presently also has several branchings 8 arranged in series, several levels 9a, 9b of sub-branches 10 and several levels 12a, 12b, 12c, 12d of divided melt channels 11a, 11b, 11c, l1d arranged between them; however seen against the designated direction 25 of flow of the polymer melt 24, namely from the output side 27 to the input side 26.

In opposition to the designated direction 25 of flow of the polymer melt 24, a melt channel 11a of the a^{th} level 12a is arranged between the respective output 7 and the branching 8; between the branching 8 and the first level 9a of sub-branches 10, a b^{th} level 12b of melt channels 11b, and between the first level 9a of sub-branches 10 and the second level 9b of sub-branches 10, a c^{th} level 12c of melt channels 11c. A d^{th} level 12d of melt channels 11d is also arranged downstream of the second level 9b of sub-branches 10, which channels are fluidically directly connected to the inputs 6. Thus, in the designated direction 25 of flow of the polymer melt 24, the number of melt channels 11 decreases with each level from the inputs 6 to the output 7; that is, every two of the presently eight melt channels 11d of the d^{th} level 12d are combined to one melt channel 11c of the c^{th} level 12c, i.e. in total four melt channels 11c of the c^{th} level 12c. Every two of the four melt channels 11c of the c^{th} level 12c are again combined to one melt channel 11b of the b^{th} level 12b, i.e. in total there are two melt channels 11b of the b^{th} level 12b, and from the two melt channels 11b of the b^{th} level 12b, a melt channel 11a of the a^{th} level is formed which is directly fluidically connected to the output 7.

In reverse order to the embodiment in FIG. 2, the local cross-section of the respective melt channel level increases in the designated direction 25 of flow of the polymer melt 24 with each lower level. The melt channels 11a of the a^{th} level 12a are oriented towards the output 7 in the designated direction 25 of flow of the polymer melt 24 and the melt channels 11b of the b^{th} level 12b are oriented towards the inputs 6 with respect to the melt channels 11a of the a^{th} level 12a. The melt channels 11c of the c^{th} level 12c are oriented towards the output 7 with respect to the melt channels 11d of the d^{th} level 12d, the melt channels 11d of the d^{th} level 12d being oriented towards the inputs 6 with respect to the melt channels 11a, 11b, 11c of the a^{th}, b^{th} and c^{th} levels 12a, 12b, 12c. Accordingly, the melt conductor 1 acts as a melt mixer.

FIG. 4 shows a third alternative multi-channel system of a third alternative melt conductor block 4 not shown here. The present multi-channel system 5 is formed as a combination of a melt conductor 1 which is partly formed as a melt distributor and partly as a melt mixer. On the input side of the melt conductor block 4, first an input 6 into the multi-channel system 5 is provided, the melt channel 11a of the a^{th} level 12a being separated into a plurality of melt channels 11d of the d^{th} level 12d in analogy to the embodiment in FIG. 2A. Further downstream in the designated direction 25 of flow of the polymer melt, starting from the melt channels 11d of the d^{th} level 12d, the melt channels 11 are again combined in a manner analogous to the embodiment in FIG. 3 via melt channels 11c, 11b of the c′^{th} level 12c′ and of the b′^{th} level 12b′ down to a melt channel 11a of the a^{th} level 12a′ or down to the output 7, respectively.

In FIG. 5, a fourth alternative multi-channel system 5 of a fourth alternative melt conductor block 4—not shown—is represented, a combination of a melt conductor 1 formed partly as a melt mixer and partly as a melt distributor being shown here as well. The method of functioning, however, is opposite to the one shown in the embodiment of FIG. 4. On its input side 26, the melt conductor block 4 has several inputs 6 to the multi-channel system 5, the melt channels 11d of the d^{th} level 12d, which are fluidically directly connected to the inputs 6, being combined along the designated direction 25 of flow of the polymer melt 24, in a manner analogous to the example of embodiment in FIG. 3, from one level to the other up to a melt channel 11a of the a^{th} level 12a. Further downstream, this melt channel 11a of the a^{th} level 12a is divided, in a manner analogous to the embodiment in FIG. 2, from one level to the other via a branching 8, several levels 9a′, 9b′ of sub-branches 10 as well as interposed levels 12b′, 12c′, 12d′ of melt channels 11b, 11c, 11d until a plurality of outputs 7 are arranged on the output side 27 of the melt conductor block 4.

The multi-channel system 5 according to the embodiment in FIG. 4 and according to the embodiment in FIG. 5 is not limited to the shape and arrangement described herein. It is also possible to provide upstream and/or downstream of the respective multi-channel system 5 additional portions formed as melt distributors and/or melt mixers which can be embodied and combined as desired. It is of an advantage, however, if the polymer melt 24 always has the same melt history at the output(s) 7, independently of which melt channels 11 or melt channel sequence it flows through. In case of eight melt channels 11d of the d^{th} level 12d, the polymer melt 24 is therefore divided into a maximum of eight different melt streams. A “same history” of the polymer melt 24 in this connection means that all melt streams of the polymer melt 24 have traversed the same path through the multi-channel system 5 when they arrive at the output(s) 7 and have flown through the same number of melt channels 11, branchings 8 and sub-branches 10.

The embodiments according to FIGS. 6A through 10B, which are described in the following, exclusively refer to melt conductors 1 formed as melt distributors, with the polymer melt 24 in the multi-channel system 5 being distributed from a respective input 6 to a plurality of outputs 7. Thus, the arrangement and numbering of the levels of melt channels 11 as well as of the branchings 8 and levels of sub-branches 10 are analogous to the first embodiment shown in FIG. 2. Naturally, the following embodiments are also suitable for implementing the melt conductor 1 as a melt mixer or as any combination of melt mixer and melt distributor.

In the embodiments according to FIGS. 1 through 5, the multi-channel system 5 is in each case substantially formed lying on one plane, the respective input 6 and output 7 as well as all melt channels 11, branchings 8 and sub-branches 10 being consequently arranged on one common plane. Therefore, at least three degrees of freedom are used for forming the multi-channel system 5.

In contrast, a fifth alternative multi-channel system 5 of a fifth alternative melt conductor block 4—not shown here—is represented in FIGS. 6A through 6C, the channel system 5 branching out three-dimensionally in space using five degrees of freedom. As shown in FIG. 6C, the melt channels 11 extend in the direction of flow of the polymer melt 24, starting from the input 6 and distributed over several levels 12a-12e, at least partly downwards, to the left, to the right, into and out of the leaf level. The melt channels 11a-11e fluidically connected to the input 6 thus branch out over the branchings 8 and sub-branches 10 down to the outputs 7 which in the present arrangement are distributed over two substantially parallel planes. The first level 9a of sub-branches 10 is formed such that the melt channels 11c of the c^{th} level 12b substantially extend rotated by 90° with respect to the melt channels 11b of the b^{th} level 12b, such that starting from each melt channel 11c of the c^{th} level, a separate distribution system 29a, 29b, 29c, 29d is formed, such that the first and the second distribution system 29a, 29b are arranged on one plane and the third and the fourth distribution system 29c, 29d are arranged on a second plane.

By means of such a melt conductor 1, it is possible in an easy manner to distribute the polymer melt 24 not only evenly in width in a manner analogous to FIG. 2 but also homogeneously in a direction transverse thereto, that is, in height or in depth, depending on the direction of view, so that the polymer melt 24 can exit from the melt conductor block 4 on a comparably large surface. This is especially suitable for manufacturing filaments or endless filaments and in particular for producing spunbonded fabrics by means of multirow nozzle dies.

Independently of the arrangement of the branching 8 and the sub-branches 10 in relation to the melt channels 11 and their arrangement in three-dimensional space, the local cross-section of the melt channels 11 decreases from one level to the next 12a-12e down to the outputs 7, the melt channels 11 of each level 12a-12e being always formed symmetrical in all distribution systems 29a-29d and the separated melt streams of the designated polymer melt 24 having the same melt history.

The outputs 7 of the first and second distribution systems 29a, 29b or of the first plane, respectively, are thus located on a theoretical straight first line and the outputs 7 of the third and the fourth distribution system 29c, 29d or of the second plane on a theoretical straight second line. Both lines and both planes are arranged in parallel to one another. Since all melt channels 11 are connected to a single input 6, all melt streams have the same material properties at the respective output 7 due to conveying the same polymer melt 24.

The melt conductor block 4 further has several inspection openings 13a-13d for the multi-channel system 5. The inspection openings 13a-13d are arranged in a curved portion 46 between a channel portion 47 which is here substantially horizontal and a substantially vertical channel portion 48 of the melt channel 11c of the c^{th} plane and extend from there each at an incline upwards in the direction of a lateral surface 49 of the melt conductor block 4. The inspection openings 13a-13d can be used for inspection or flushing of the multi-channel system 5 and can accordingly have basically any configuration on the multi-channel system 5. In the present example of embodiment, the first and the second inspection opening 13a, 13b are formed such that they each exit from the melt conductor block 4 via a respective curved portion 50 perpendicularly to a substantially vertical lateral surface 49 of the melt conductor block 4. By way of example, the third and the fourth inspection opening 13c, 13d are configured such that they each exit from the melt conductor block 4 via a respective curved portion 50 perpendicularly to a horizontal lateral surface 49 of the melt conductor block 4.

In addition, the melt conductor block 4 has a medium channel 20 extending spatially between the melt channels 11 of the multi-channel system 5, here between the two levels of the distribution systems 29a-29d, and implements a fluid guidance. The fluid guidance is used for temperature control of the melt conductor block 4 and therefore of the polymer melt 24 guided in the multi-channel system 5. The medium channel 20 is not fluidically connected to the melt channels 11 of the multi-channel system 5 and implements temperature control of the melt conductor 1 and in particular of the melt conductor block 4 during operation of the extrusion facility 3. Furthermore, any number of additional medium channels of any structure can be provided which are arranged fluidically separated from the melt channels 11 of the multi-channel system 5 in the melt distributor block 4. The additional medium channels can also be embodied as drying shafts which are adapted, for instance, for accommodating an electric line and/or a measuring unit.

In FIGS. 7A through 7D, a sixth alternative multi-channel system 5 of a sixth alternative melt conductor block 4—not shown here—is represented, the multi-channel system here branching out three-dimensionally in space using six degrees of freedom. In this embodiment, it is shown that the two melt channels 11b of the b^{th} level partly extend in opposition to a global machine direction 18. The global machine direction 18 leads from the input 6 to the output 7 of a designated melt flow of the polymer melt 24. Each melt channel 11b of the b^{th} level 12b has a local machine direction 19 which can always be the same in the longitudinal direction of the melt channel 11 or which may change in the longitudinal direction of the melt channel 11, depending on the configuration and extension of the respective melt channel 11. It may be of an advantage if the local machine direction extends at least partially against the global machine direction 18. This can especially be seen in FIG. 7A.

A “global machine direction” 18 is the arrangement of the melt conductor 1, in particular the melt conductor block 4, in the extrusion facility 3, the global machine direction 18 extending along the designated direction of flow between the provision unit and the extrusion nozzle 14 on the melt conductor block 4. That is, the global machine direction 18 is a spatial extension of the melt conductor 1, in particular the melt conductor block 4, in the extrusion facility 3 taking into account the input side 26 and the output side 27 of the multi-channel system 5 for the designated polymer melt 24.

A “local machine direction” 19 may deviate locally from the global machine direction 18, the local machine direction 19 referring to the local orientation of the multi-channel system 5, in particular of the respective melt channel 11 in relation to the global machine direction 18. The local machine direction 19 extends coaxially with the longitudinal axis of the melt channel 11 in the designated direction 25 of flow of the polymer melt 24. In a particularly simplified case, the local machine direction 19 can in portions preferably coincide with the global machine direction 18 if the multi-channel system 5 has an input 6 on an input side of the melt conductor block 4 and an output 7, which is fluidically connected and coaxially arranged therewith, on an output side of the melt conductor block 4 opposite to the input side. The orientation of the melt channel 11 in space and thus the local machine direction 19 can, in this case, be at least partially coaxial with the global machine direction 18.

Since the multi-channel system 5 is formed so as to extend three-dimensionally inside the melt conductor 1 or the melt conductor block 4, respectively, the local machine direction 19 regularly deviates from the global machine direction 18. Because all six degrees of freedom can be exploited to form the multi-channel system 5, an inclined arrangement of the respective melt channel 4 with respect to the global machine direction 18 is possible. It is also conceivable, however, and can be advantageous, especially for saving installation space, to provide for the local machine direction 19 to extend, with respect to the global machine direction 18, in portions in the opposite direction.

Thus, in a particular example of embodiment, melt channels 11 of the multi-channel system 5 can be guided back nearly to the input side of the melt conductor 1, in particular the melt conductor block 4. The advantage of guiding the local machine direction 19 of the melt channels 11 opposite to the global machine direction 18 therefore consists in the fact that since any desired arrangement of the melt channels 11 in relation to the global machine direction 18 is possible, the melt conductor 1 or melt conductor block 4 can be embodied such as to save a large amount of installation space. In addition, the melt channels 11 can be arranged to bypass connecting or fastening elements—not shown here—as desired, in particular screws, threads or the like.

In the present case, the input 6 and the outputs 7 of the multi-channel system 5 are substantially arranged on a first plane, the melt channels 11b of the b^{th} level 12b extending partly transversely to this first plane such that the first level 9a of sub-branches 10 is arranged on a second plane parallel to the first plane. The attached melt channels 11c of the c^{th} level 12c extend partly on the second plane and are guided back to the first plane for further distribution of the polymer melt 24. By guiding the melt channels 11 three-dimensionally in space, and in particular by guiding the local machine direction 19 of the melt channels 11 partly against the global machine direction 18, the polymer melt 24 is broadly distributed over a smaller axial construction space, that is, in the global machine direction 18 of the melt conductor 1. In this manner, the melt conductor 1 can be constructed to be more compact.

By means of such a melt conductor block 4, it is possible to distribute the polymer melt 24 such that in particular non-woven fabrics with 20 to 10,000 individual filaments per meter width can be produced.

FIG. 8 shows a seventh example of embodiment with a seventh alternative multi-channel system 5. The multi-channel system 5 is substantially identical with the multi-channel system 5 in FIG. 2. The main difference is that the melt distributor block 4, here in the area of the melt channels 11c of the c^{th} level 12c, each has a static functional element 21 in the form of a static mixing element for influencing the designated polymer melt 24. The respective functional element 21 is arranged within a local broadening 28 of the melt channels 11c of the c^{th} level 12c and has the form of intersecting struts. The respective functional element 21 is arranged in one of the melt channels 11c of the c^{th} level 12c between a sub-branch 10 of the first level 9a and a sub-branch 10 of the second level 9b. Before and after the local broadening 28, the cross-sectional dimension and shape of the respective melt channel 11c of the c^{th} level 12c are substantially equal. The respective static functional element 21 achieves a mixing of the polymer melt 24 conducted and distributed inside the melt channels 11c of the c^{th} level 12c. In this manner homogenization of the melt strand conducted inside the respective melt channel 11 of the polymer melt 24, in particular of its flow and material properties, can be ensured. Alternatively, the static mixing element can also be arranged directly within the respective melt channel and not in a local broadening.

As an alternative, an eighth embodiment according to FIG. 9 shows an eighth alternative multi-channel system 5 which has, instead of the broadening 29 with the functional element 21 arranged therein, a pump 36 as a means for at least indirectly influencing the polymer melt 24 at the respective melt channel 11c of the c^{th} level 12c in order to convey the polymer melt through the multi-channel system 5. The provision of pumps 36 is an advantage in multi-channel systems with a plurality of melt channel levels and branching levels, the polymer melt being distributed over a large width of the melt conductor block 4 or joined from a large width of the melt conductor block 4, respectively. The embodiment in FIG. 9 can easily be combined with the embodiment in FIG. 8.

FIGS. 10A and 10B show a ninth alternative example of embodiment of a ninth alternative multi-channel system 5. The multi-channel system 5 is formed in a manner substantially analogous to the multi-channel system 5 in FIG. 2. We therefore refer to the corresponding description, where for reasons of simplicity, a repetition of identical reference numbers is omitted unless it is absolutely necessary.

In addition to the multi-channel system 5, the melt conductor block 4 also has a through opening 17 formed as a channel system which is fluidically connected with the multi-channel system 5 in the area of the outputs 7 of the multi-channel system 5 via junctions 15 so as to conduct a medium towards and/or away from the multi-channel system 5, depending on requirements.

Here, the through opening 17 is embodied for adding an additive into the melt channel 11d of the d^{th} level 12d of the multi-channel system 5. In other words, an additive—not shown in detail here—is added into a first input 38 of the through opening 17, the additive being distributed via the channels 39 such that one channel 39 of the through opening 17 is connected with one corresponding melt channel 11d of the d^{th} level 12d of the multi-channel system 5 via a respective junction 15. Thus, the additive is mixed with the polymer melt 24 by means of the junctions 15 so as to achieve certain material properties of the polymer melt 24.

Thus, the through opening 17 formed as a channel system has, in a manner analogous to the multi-channel system 5, channels 39 which are separated via branchings 8 and several levels 9a of sub-branches 10 such that additives can be added to the melt streams of the polymer melt 24 flowing in the melt channels 11d of the d^{th} level 12d of the multi-channel system 5. Here, the polymer melt 24 in the multi-channel system 5 and the additive in the through opening 17 are only combined directly before exiting the multi-channel system or the melt conductor block 4. In this manner, a compound is produced which is atomized via the outputs 7 or directed to an extrusion nozzle (not shown here).

In addition, the channels 39 of the through opening 17 can be arranged in parallel, perpendicular or at an incline to the melt channels 11 of the multi-channel system 5. Here, the channels 39 of the through opening 17 conducting the additive are arranged at an incline such that from one level to the next, the channels 39 continuously approach the melt channels 11a-11d of the multi-channel system 5 until the channels 39 and the melt channels 11d of the d^{th} level 12d meet in the area of the respective junction 15 and achieve mixing of the designated polymer melt 24 with the additive.

Alternatively, a venting, e.g a discharge of gases from the multi-channel system 5 can also be performed via the channel system of the through opening 17. The junctions 15 can also be arranged in different places of the multi-channel system 5, especially in the area of other levels of melt channels 11, branchings 8 or sub-branches 10.

In FIGS. 11 through 16, different embodiments of means for at least indirectly influencing the polymer melt 24 are shown. They can be arranged in individual melt channels 11, in several melt channels 11 of one level or in all melt channels 11 of the multi-channel system 5 and can be combined as desired, depending on requirements on the polymer melt and/or on the extrusion product 30.

FIG. 11 shows a partial sectional view of a melt channel 11 of the multi-channel system 5—not shown here in detail—according to a tenth alternative embodiment. Here, the means for at least indirectly influencing the polymer melt 24 comprise an actuator 33 driving a wheel 40 arranged inside the melt channel 11 and rotatable about a rotational axis R. The rotational axis R of the wheel 40 here extends transversely to the designated direction 25 of flow of the polymer melt 24. The rotation of the wheel 40 is controlled by means of a control unit 44 arranged outside the melt conductor block 4, which can comprise an adaptation of a rotational direction and/or rotational speed and/or an activation or deactivation of a rotation of the wheel 40. By means of the wheel 40, the polymer melt 24 (not shown here) flowing in the direction 25 of flow is mixed and homogenized. The actuator 33 can be activated or deactivated depending on the material properties, in particular the flow properties, of the polymer melt 24. The actuator 33 comprises a drive unit (not shown here) for driving the wheel 40 which is also arranged inside the melt conductor block and in the area of the melt channel 11.

The rotational axis R of the wheel 40 can alternatively be arranged in parallel to the designated direction 25 of flow of the polymer melt 24 so that the wheel 40 mixes the polymer melt in the form of a propeller, rotor or turbine wheel. It is also possible to arrange the wheel 40 in the melt channel 11 so that it is not driven.

In FIGS. 12A and 12B, the means for at least indirectly influencing the polymer melt 24 is embodied in an eleventh alternative embodiment as a bimetal 34. The bimetal 34 is here arranged circumferentially around the melt channel 11 and consists of a first layer 41a and a second layer 41b arranged radially outside the same, the second layer 41b resting with its entire surface on the first layer 41a. The bimetal 34 is here produced by means of an additive manufacturing method as well, namely during formation of the melt channel 11.

The layers 41a, 41b of the bimetal consist of two different metals with different thermal expansion coefficients, the metals being mutually material and/or form-fitting connected. Due to the different thermal expansion coefficients of the metals, one of the layers 41a, 41b, presently the first layer 41a, expands due to heating of the melt conductor block 4 and/or the polymer melt 24 more than the other, causing the bimetal to locally deform. At a first temperature of the bimetal 34, shown here in FIG. 12A, the melt channel 11 has a first diameter D1 which is larger than a second diameter D2 of the melt channel 11 shown in FIG. 12B which adjusts to a second temperature when the bimetal 34 is heated. Therefore, a temperature-dependent local tapering of the local cross-section of the melt channel 11 takes place due to a heating of the bimetal 34. Alternatively, the bimetal 34 or the metal layers 41a, 41b of the bimetal 34 can be embodied such that widening of the local cross-section of the melt channel 11 takes place due to heating so that D2 is larger than D1.

FIG. 13 shows a partial longitudinal section through a melt channel 11 according to a twelfth example of embodiment, with a part 35 arranged movably within the melt channel 11 as a means for influencing the polymer melt 24. The movably arranged part 35 is a wheel 40 arranged rotatably with respect to the melt conductor block 4 or the wall of the melt channel 11 which rotates, due to kinetic energy of the polymer melt 24 flowing in the designated direction 25 of flow, about a rotational axis R and allows mixing of the polymer melt 24 in a manner substantially analogous to FIG. 11.

In FIG. 14, a partial sectional view of a melt channel 11 of the multi-channel system 5 according to a thirteenth alternative embodiment, the means for at least indirectly influencing the polymer melt 24 comprise a manipulating device 32, which can be selectively and alternately activated and deactivated, for manipulating melt areas arranged in the melt conductor block 4 for directing polymer melt 24. In other words, the designated polymer melt 24 conducted inside the melt channels 11 is influenced by switching the manipulating device 32 on and off. Here, the manipulating device 32 is temperature-controlled. This means that a control or an alteration of the properties of the polymer melt 24 is performed by means of the manipulating device 32 in dependence on the temperature of the material of the melt conductor block 4 and/or on the temperature of the polymer melt 24.

In the present example of embodiment, the manipulating device 32 is embodied as a heating strip arranged at least partly circumferential and radially spaced from the melt channel 11. The heating strip is sleeve-shaped, an activation or deactivation of the heating strip taking place in dependence on the temperature of the designated polymer melt 24. Activation of the manipulating device 32 may for instance be necessary to reduce the viscosity of the designated polymer melt 24. In contrast, deactivation of the manipulating device 32 may be necessary if the melt conductor block 4 has a desired material temperature, which guarantees certain flow properties of the designated polymer melt 24, making an additional reduction of viscosity unnecessary.

Alternatively or in addition, it is possible to effectively arrange heating elements and/or heating strips of the manipulating device 32 on outer surfaces of the melt conductor block 4 as means to at least indirect influencing so as to achieve temperature control in some or all parts of the melt conductor block 4 and thus in the polymer melt 24 conveyed in the melt channels 11 inside the melt conductor block 4.

FIG. 15 shows a partial longitudinal section through a melt conductor block 4 according to a fourteenth example of embodiment. Here, the multi-channel system is partially shown, a replaceable plug-in element 31 being accommodated in a recess 42—shown in dashed lines—of the melt conductor block 4 and being adapted to locally alter a channel geometry of at least one of the melt channels 11 and/or to fluidically interconnect at least two of the melt channels 11 of the multi-channel system 5. In the present embodiment, the plug-in element 31 has a branching 8 which divides a first melt channel 11a into two second melt channels 11b of a level downstream in the direction 25 of flow of the designated polymer melt 24. Here, the plug-in element 31 is embodied such that a local cross-section of the melt channels 11a, 11b remains constant. It is also conceivable, however, that the shape and/or type of cross-section of the melt channels 11a, 11b within the plug-in element 31 may change. It is also possible to arrange inside the plug-in element 31 means for at least indirectly influencing the polymer melt 24 as are described in FIGS. 11 through 14 or FIG. 16. This allows reacting to the requirements on the polymer melt 24 and/or the extrusion product 30 by simply replacing the plug-in element 31, for instance if polymer melts 24 or the desired type of product are changed. In particular, the flow properties of the polymer melt 24 and/or melt conveyance of the multi-channel system 5 may be adapted.

In FIG. 16, the means for at least indirectly influencing the polymer melt 24 according to an eleventh alternative embodiment is embodied as a cross-section modification means 37, in the present case as a valve. The cross-section modification means 37—not shown in detail here—is arranged replaceably in the melt conductor block 4, which is only partially shown here, and is inserted via an external access 45 into a valve seat 16 formed in the melt channel 11. The cross-section modification means 37 is formed such that the melt channel 11 is sealed with respect to the external access 45. In addition, the cross-section modification means 37 embodied as a valve is configured to adapt a flow rate of the melt channel 11, where the flow rate can be changed during operation of the extrusion facility 3. Due to replaceable arrangement of the cross-section modification means 37 on the melt conductor block 4, the external access 45 can also be configured as an inspection opening or as a through opening for feeding or discharging a medium to or from the multi-channel system 5.

Depending on the configuration of the means for at least indirectly influencing the polymer melt, for instance in the form of a flap (not shown here) or a wall displaceable as desired by means of an actuator, individual melt channels and therefore individual or several segments of the multi-channel system can be temporarily closed, making it possible to produce by means of the extruding die extrusion products with different widths or to continuously alter the widths.

At this point, it is explicitly pointed out that features of the solutions described above, in the Claims or in the Figures can also be combined, if desired, so as to cumulatively achieve the features, effects and advantages. It is also explicitly mentioned that the embodiments in FIGS. 1 through 10B can also be implemented with two or more multi-channel systems.

It is understood that the embodiments explained above are only first embodiments of the invention, in particular of the melt conductor 1, the extruding die 2 and the extrusion facility 3 according to the invention. Thus, the implementation of the invention is not limited to these embodiments.

All features disclosed in the application documents are claimed as essential to the invention provided that they are novel individually or in combination with respect to the state of the art.

The embodiments shown here are only examples of the present invention and are therefore not to be understood as limiting. Alternative embodiments considered by the person skilled in the art are equally comprised by the scope of protection of the present invention.

### LIST OF REFERENCE NUMBERS

1 melt conductor
2 extruding die
3 extrusion facility
4 melt conductor block
5 multi-channel system
6 input of multi-channel system
7 output of multi-channel system
8 branching
9a first level of a branching
9b second level of a branching
9c third level of a branching
10 sub-branch
11 melt channel
11a divided melt channel of a first level
11b divided melt channel of a second level
11c divided melt channel of a third level
11d divided melt channel of a fourth level
11e divided melt channel of a fifth level
12a a^{th} level of a melt channel
   12a′ a′^{th} level of a melt channel
12b b^{th} level of a melt channel
12b′ b′^{th} level of a melt channel
12c c^{th} level of a melt channel
12c′ c′^{th} level of a melt channel
12d d^{th} level of a melt channel
12d′ d′^{th} level of a melt channel
12e e^{th} level of a melt channel
13a first inspection opening
13b second inspection opening
13c third inspection opening
13d fourth inspection opening
14 extrusion nozzle
15 junction
16 valve seat
17 through opening
18 global machine direction
19 local machine direction
20 medium channel
21 static functional element
22 extrusion nozzle output
23 provision unit
24 polymer melt
25 flow direction of polymer melt
26 input side of melt conductor block
27 output side of melt conductor block
28 local expansion of melt channel
29 polymer
30 extrusion product
31 plug-in element
32 manipulating device
33 actuator
34 bimetal
35 movably arranged part
36 pump
37 cross-section modification means
38 input of through opening
39 channel of through opening
40 wheel
41a first layer of bimetal
41b second layer of bimetal
42 recess in melt conductor block
43 valve
44 control unit
45 external access
46 curve portion of melt channel
47 horizontal channel portion of melt channel
48 vertical channel portion of melt channel
49 outer surface of melt conductor block
50 curve portion of inspection opening
B width of extrusion nozzle output
D1 first diameter of melt channel
D2 second diameter of melt channel
R rotational axis

1. Melt conductor, in particular melt distributor or melt mixer, for an extruding die of an extrusion facility,
comprising a melt conductor block with a multi-channel system,
the multi-channel system being arranged with three-dimensional extension inside the melt conductor block and having at least one input and at least one output for polymer melt,
where between an input and an output fluidically connected to the input, several branchings arranged in series and several levels of sub-branches are formed over several levels of divided melt channels,
m melt channels of the a^{th} level with x^{th} local cross-sections and n melt channels of the b^{th} level with y^{th} local cross-sections being present,
wherein n>m if b>a,
the y^{th} local cross-sections of the melt channels of the b^{th} level being smaller than the x^{th} local cross-sections of the melt channels of the a^{th} level (12a),
and wherein
in the designated direction of flow of the polymer melt, the melt channels of the a^{th} level are oriented towards the input and the melt channels of the b^{th} level towards the output such that the melt conductor acts as a melt distributor for a designated melt stream of the polymer melt,
or
in the designated direction of flow of the polymer melt, the melt channels of the a^{th} level are oriented towards the output and the melt channels of the b^{th} level towards the input, such that the melt conductor acts as a melt mixer for a designated melt stream of the polymer melt,
and wherein in the area of the multi-channel system, means for at least indirectly influencing polymer melt are arranged.

2. Melt conductor according to claim 1, wherein a means for at least indirectly influencing the polymer melt is a static functional element, an actuator, a bimetal, a part arranged movably in a melt channel, a pump, a replaceable plug-in element and/or a cross-section modification means for the multi-channel system.

3. Melt conductor according to claim 1, wherein the melt conductor, in particular the melt conductor block, has an inspection opening with an external access to the multi-channel system.

4. Melt conductor according to claim 1, wherein the melt conductor, in particular the melt conductor block, has a valve seat with an external access to the multi-channel system.

5. Melt conductor according to claim 1, wherein one the melt conductor, in particular the melt conductor block, has a through opening with an external access to the multi-channel system, by means of which a medium can be conveyed towards and/or away from the multi-channel system.

6. Melt conductor according to claim 5, wherein the through opening is configured for adding an additive in at least one melt channel of the multi-channel system.

7. Melt conductor according to claim 2, wherein the replaceable plug-in element is adapted to locally alter a channel geometry of at least one of the melt channels and/or to fluidically interconnect at least two of the melt channels of the multi-channel system.

8. Melt conductor according to claim 1, wherein a means for at least indirectly influencing the polymer melt is a manipulating device which can be selectively and alternately activated and deactivated for manipulating melt areas arranged inside the melt conductor block for conveying polymer melt.

9. Melt conductor according to claim 8, wherein the manipulating device is temperature-controlled.

10. Melt conductor according to claim 1, wherein the bimetal is adapted to locally alter a channel geometry of at least one of the melt channels in dependence on a temperature change at the melt conductor block.

11. Melt conductor according to claim 1, wherein the melt conductor block has a medium channel, in particular for a circulating fluid supply, especially for temperature control, and/or for an electric line and/or a measuring unit.

12. Melt conductor according to claim 2, wherein the static functional element is a static mixing element.

13. Extruding die for an extrusion facility for manufacturing extrusion products, comprising a melt conductor according to claim 1, the melt conductor being adapted to distribute and/or mix at least one designated polymer melt.

14. Extruding die according to claim 13, characterized by an extrusion nozzle output having a width of more than 5,000 mm, preferably more than 6,000 mm or more than 8,000 mm.

15. Extrusion facility for manufacturing extrusion products, comprising an extruding die according to claim 13.

16. Method of operating an extrusion facility according to claim 15, the extrusion facility being fed with at least one extrudible polymer, in particular at least one plastic, which is plasticized to form a respective polymer melt, the respective polymer melt being fed to the melt conductor which distributes and/or mixes the respective polymer melt.
